(19) United States
(12) Patent Application Publication
(10) Pub. No.: US 2023/0099316 A1
(43) Pub. Date: Mar. 30, 2023

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Erina SAITO, Kanagawa (JP); Tomohito NAKAJIMA, Kanagawa (JP); Daisuke ISHIZUKA, Kanagawa (JP); Tsutomu FURUTA, Kanagawa (JP)

(73) Assignee: FUJIFILM Business Innovation Corp., Tokyo (JP)

(21) Appl. No.: 17/711,011

(22) Filed: Mar. 31, 2022

(30) Foreign Application Priority Data
Sep. 27, 2021 (JP) 2021-157167

(51) Int. Cl. G03G 9/087; G03G 9/097; G03G 15/08

(52) U.S. Cl. CPC G03G 9/08797; G03G 9/08755; G03G 9/09725; G03G 9/08795; G03G 15/0877

(57) ABSTRACT

An electrostatic charge image developing toner that has a binder resin that contains a crystalline resin and toner particles that contain resin particles, in which a loss coefficient tan δS (30) at 30° C. of the resin particles is 1 or more, and a loss coefficient tan δS (50) at 50° C. of the resin particles is less than 1.

### CROSS-REFERENCE TO RELATED APPLICATIONS

This application is based on and claims priority under 35 USC 119 from Japanese Patent Application No. 2021-157167 filed Sep. 27, 2021.

### BACKGROUND

### (i) Technical Field

The present invention relates to an electrostatic charge image developing toner, an electrostatic charge image developer, a toner cartridge, a process cartridge, an image forming apparatus, and an image forming method.

### (ii) Related Art

JP2015-052714A describes “an electrostatic charge image developing toner containing at least a binder resin that includes an amorphous resin and resin particles that have an elastic modulus of 10⁴ Pa or more and 10⁶ Pa or less at 30° C. and an elastic modulus of 10⁴ Pa or more and 10⁶ Pa or less at 100° C.”.

### SUMMARY

Aspects of non-limiting embodiments of the present disclosure relate to an electrostatic charge image developing toner that has a binder resin including a crystalline resin and toner particles containing resin particles, the electrostatic charge image developing toner further suppressing gloss unevenness that may occur after the temperature of an image is raised, compared to an electrostatic charge image developing toner that contains the resin particles having a loss coefficient tan δS (30) at 30° C. of less than 1 or having a loss coefficient tan δS (50) at 50° C. of 1 or more or yields a gloss rate of change of an image of less than 0% or higher than 10.0% before and after a 25 mm×25 mm square image formed at a toner application amount of 13.5 g/m² is heated for 30 days at 50° C.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

The above aspects are achieved by the following means. According to an aspect of the present disclosure, there is provided an electrostatic charge image developing toner having a binder resin that contains a crystalline resin and toner particles that contain resin particles,

in which a loss coefficient tan δS (30) at 30° C. of the resin particles is 1 or more, and a loss coefficient tan δS (50) at 50° C. of the resin particles is less than 1.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

The exemplary embodiments as an example of the present invention will be described below. The following descriptions and examples merely illustrate the exemplary embodiments, and do not limit the scope of the invention.

Regarding the ranges of numerical values described in stages in the present specification, the upper limit or lower limit of a range of numerical values may be replaced with the upper limit or lower limit of another range of numerical values described in stages. Furthermore, in the present specification, the upper limit or lower limit of a range of numerical values may be replaced with values described in examples.

In the present specification, “(meth)acryl” means both the acryl and methacryl.

Each component may include a plurality of corresponding substances.

In a case where the amount of each component in a composition is mentioned, and there are two or more kinds of substances corresponding to each component in the composition, unless otherwise specified, the amount of each component means the total amount of two or more kinds of the substances present in the composition.

### Electrostatic Charge Image Developing Toner

The electrostatic charge image developing toner according to a first exemplary embodiment (hereinafter, also called “toner”) has a binder resin that contains a crystalline resin and toner particles that contain resin particles.

A loss coefficient tan δS (30) at 30° C. of the resin particles is 1 or more, and a loss coefficient tan δS (50) at 50° C. of the resin particles is less than 1.

Hereinafter, the resin particles having the loss coefficient tan δS (30) at 30° C. of 1 or more and the loss coefficient tan δS (50) at 50° C. of less than 1 will be also called specific resin particles.

Due to the above configuration, the toner according to the first exemplary embodiment may excellently suppress the gloss unevenness that may occur after the temperature of an image is raised. The reason is presumed as follows.

In a case where the temperature of an image, which is obtained using a toner having a binder resin that contains a crystalline resin and toner particles that contain resin particles, is raised, the crystalline resin contained in the image is likely to ooze out on the surface of the image. The crystalline resin having oozed out on the surface of the image may be compatible with the binder resin again, which is likely to smooth the surface of the image and induce gloss unevenness of the image.

The resin particles in the toner according to the first exemplary embodiment have a loss coefficient tan δS (30) at 30° C. of 1 or more, which tells that the resin particles have the properties of a viscous material at 30° C. and the molecules in the resin particles perform molecular motion. Because the molecules of the crystalline resin also perform molecular motion at around 30° C., the affinity between the resin particles and the crystalline resin tends to be high. Therefore, the resin particles and the crystalline resin are likely to be close to each other in an image, and the effect of suppressing smoothing of the image surface, which will be described later, is likely to be further enhanced.

A loss coefficient tan δS (50) at 50° C. of the resin particles is less than 1, which tells that the resin particles have the properties of an elastic material at 50° C. Under the condition of 50° C., the crystalline resin contained in the image is likely to ooze out on the image surface and to be compatible again with the binder resin. Because the resin particles have elasticity under such temperature conditions, the crystalline resin and the binder resin are likely to be inhibited from being compatibility with each other, and the smoothing of the image surface is likely to be suppressed.

It is considered that for the aforementioned reasons, the toner according to the first exemplary embodiment may excellently suppress gloss unevenness that may occur after the temperature of an image is raised.

The toner according to a second exemplary embodiment contains toner particles containing a binder resin that contains a crystalline resin and resin particles.

Furthermore, this toner yields a gloss rate of change of an image of 0% or more and 10.0% or less before and after heating the image at 50° C. for 30 days, the image being a 25 mm×25 mm square image formed at a toner application amount of 13.5 g/m².

Due to the above configuration, the toner according to the second exemplary embodiment may excellently suppress the gloss unevenness that may occur after the temperature of an image is raised. The reason is presumed as follows.

Yielding an absolute value of a gloss difference of an image of 0% or more and 10.0% or less before and after heating the image at 50° C. for 30 days, the image being a 25 mm×25 mm square image formed at a toner application amount of 13.5 g/m², means that the difference in gloss of the image before and after raising the temperature of the image is small. Therefore, the image is unlikely to be more glossy even after the temperature of the image is raised.

It is considered that for the aforementioned reasons, the toner according to the second exemplary embodiment may excellently suppress gloss unevenness that may occur after the temperature of an image is raised.

Hereinafter, a toner corresponding to any of the toners according to the first or second exemplary embodiment will be specifically described. Here, an example of the toner according to an exemplary embodiment of the present invention may be a toner corresponding to any one of the toners according to the first or second exemplary embodiment.

### Toner Particles

The toner particles contain a binder resin containing a crystalline resin and resin particles, and are configured with a colorant, a release agent, and other additives, as necessary.

### Binder Resin

Examples of the binder resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more of kinds of these binder resins may be used in combination.

Especially, the binder resin contains a crystalline resin. For example, the binder resin contains a crystalline resin and an amorphous resin.

The crystalline resin means a resin having a clear endothermic peak instead of showing a stepwise change in amount of heat absorbed, in differential scanning calorimetry (DSC).

In contrast, the amorphous resin means a resin which shows only a stepwise change in amount of heat absorbed instead of having a clear endothermic peak in a case where the resin is measured by a thermoanalytical method using differential scanning calorimetry (DSC), and stays as a solid at room temperature but turns thermoplastic at a temperature equal to or higher than a glass transition temperature.

Specifically, for example, the crystalline resin means a resin which has a half-width of an endothermic peak of 10° C. or less in a case where the resin is measured at a heating rate of 10° C./min, and the amorphous resin means a resin which has a half-width of more than 10° C. or a resin for which a clear endothermic peak is not observed.

The crystalline resin will be described.

Examples of the crystalline resin include known crystalline resins such as a crystalline polyester resin and a crystalline vinyl resin (for example, a polyalkylene resin, a long-chain alkyl (meth)acrylate resin, and the like). Among these, in view of mechanical strength and low-temperature fixability of the toner, for example, a crystalline polyester resin is preferable.

### Crystalline Polyester Resin

Examples of the crystalline polyester resin include a polycondensate of a polyvalent carboxylic acid and a polyhydric alcohol. As the crystalline polyester resin, a commercially available product or a synthetic resin may be used.

The crystalline polyester resin easily forms a crystal structure. Therefore, for example, a polycondensate which uses not a polymerizable monomer having an aromatic group but a polymerizable monomer having a linear aliphatic group is preferable.

Examples of the polyvalent carboxylic acid include aliphatic dicarboxylic acids (for example, oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, and the like), aromatic dicarboxylic acids (for example, dibasic acids such as phthalic acid, isophthalic acid, terephthalic acid, and naphthalene-2,6-dicarboxylic acid), anhydrides of these, and lower alkyl esters (for example, having 1 or more and 5 or less carbon atoms) of these.

As the polyvalent carboxylic acid, a carboxylic acid having a valency of 3 or more that has a crosslinked structure or a branched structure trivalent or higher carboxylic acid having a crosslinked structure or a branched structure may be used in combination with a dicarboxylic acid. Examples of trivalent carboxylic acids include aromatic carboxylic acids (for example, 1,2,3-benzenetricarboxylic acid, 1,2,4-benzenetricarboxylic acid, 1,2,4-naphthalenetricarboxylic acid, and the like), anhydrides of these, and lower alkyl esters (for example, having 1 or more and 5 or less carbon atoms) of these.

As the polyvalent carboxylic acid, a dicarboxylic acid having a sulfonic acid group and a dicarboxylic acid having an ethylenic double bond may be used in combination with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in the main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, and the like. As the aliphatic diol, among these, for example, 1,8-octanediol, 1,9-nonanediol, and 1,10-decanediol are preferable.

As the polyhydric alcohol, an alcohol having three or more hydroxyl groups and a crosslinked structure or a branched structure may be used in combination with a diol. Examples of the alcohol having three or more hydroxyl groups include glycerin, trimethylolethane, trimethylolpropane, pentaerythritol, and the like.

One kind of polyhydric alcohol may be used alone, or two or more kinds of polyhydric alcohols may be used in combination.

The content of the aliphatic diol in the polyhydric alcohol may be 80 mol % or more and, for example, preferably 90 mol % or more.

The melting temperature of the crystalline polyester resin is, for example, preferably 50° C. or higher and 120° C. or lower, more preferably 55° C. or higher and 110° C. or lower, and even more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline polyester resin is, for example, preferably 6,000 or more and 50,000 or less.

The crystalline polyester resin can be obtained by a known manufacturing method, for example, just as amorphous polyester.

The amorphous resin will be described.

Examples of the amorphous resin include known amorphous resins such as an amorphous polyester resin, an amorphous vinyl resin (for example, a styrene acrylic resin), an epoxy resin, a polycarbonate resin, and a polyurethane resin. Among these, for example, an amorphous polyester resin and an amorphous vinyl resin (particularly, a styrene acrylic resin) are preferable, and an amorphous polyester resin is more preferable.

Amorphous Polyester Resin

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among these, for example, aromatic dicarboxylic acids are preferable as the polyvalent carboxylic acid.

As the polyvalent carboxylic acid, a carboxylic acid having a valency of 3 or more that has a crosslinked structure or a branched structure trivalent or higher carboxylic acid having a crosslinked structure or a branched structure may be used in combination with a dicarboxylic acid. Examples of the carboxylic acid having a valency of 3 or more include trimellitic acid, pyromellitic acid, anhydrides of these, lower alkyl esters (for example, having 1 or more and 5 or less carbon atoms) of these, and the like.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among these, for example, aromatic diols and alicyclic diols are preferable as the polyhydric alcohol, and aromatic diols are more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is for example, preferably 50° C. or higher and 80° C. or lower, and more preferably 50° C. or higher and 70° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC⋅HCL-8120GPC manufactured by Tosoh Corporation as a measurement device, TSKgel⋅Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The amorphous polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where a monomers as a raw material are is not dissolved or compatible at the reaction temperature, in order to dissolve the monomers, a solvent having a high boiling point may be added as a solubilizer. In this case, a polycondensation reaction is carried out in a state where the solubilizer is being distilled off. In a case where a monomer with poor compatibility takes part in the reaction, the monomer with poor compatibility may be condensed in advance with an acid or an alcohol that is to be polycondensed with the monomer, and then polycondensed with the major component.

The content of the binder resin with respect to the total mass of the toner particles is, for example, preferably 40% by mass or more and 98% by mass or less, more preferably 50% by mass or more and 97% by mass or less, and even more preferably 60% by mass or more and 95% by mass or less.

A mass ratio (C/A) of a content C of the crystalline resin to a content A of the amorphous resin is, for example, preferably 3/97 or more and 50/50 or less, and more preferably 5/95 or more and 30/70 or less.

Specific Resin Particles

The specific resin particles have a loss coefficient tan δS (30) at 30° C. of 1 or more and a loss coefficient tan δS (50) at 50° C. of less than 1.

The loss coefficient of the specific resin particles is a value measured using a rheometer.

As the rheometer, for example, “ARES-G2 (trade name)” manufactured by TA Instruments LTD can be used.

Hereinafter, the procedure for measuring the loss coefficient tan δS (30) at 30° C. and the loss coefficient tan δS (50) at 50° C. will be specifically described.

Resin particles as a measurement target are molded by heating at 100° C., thereby preparing a disk-shaped sample having a thickness of 1 mm and a diameter of 8 mm. The disk-shaped sample is sandwiched between parallel plates having a diameter of 8 mm, and the loss coefficient is measured using a rheometer under measurement conditions of frequency: 1 Hz and strain: 0.03% or more and 20% or less. At this time, the temperature of the disk-shaped sample is raised from 25° C. to 140° C. at a heating rate of 1° C./min, and the loss coefficient with respect to the temperature change is measured.

The loss coefficient of the disk-shaped sample measured at 30° C. is adopted as a loss coefficient tan δS (30), and the loss coefficient of the disk-shaped sample measured at 50° C. is adopted as a loss coefficient tan δS (50).

The loss coefficient tan δS (30) at 30° C. of the specific resin particles is, for example, preferably 1.1 or more and 3 or less, more preferably 1.2 or more and 2.7 or less, and even more preferably 1.3 or more and 2.5 or less.

The loss coefficient tan δS (50) at 50° C. of the specific resin particles is, for example, preferably 0.1 or more and 0.9 or less, more preferably 0.2 or more and 0.8 or less, and even more preferably 0.25 or more and 0.7 or less.

The difference between the loss coefficient tan δS (30) and the loss coefficient tan δS (50) (tan δS (30)−tan δS (50)) is, for example, preferably 0.5 or more, more preferably 0.8 or more and 3.0 or less, and even more preferably 1.0 or more and 2.5 or less.

In a case where the difference (tan δS (30)−tan δS (50)) is within the above numerical range, the value of loss coefficient of the resin particles is likely to be slowly reduced as the temperature of the specific resin particles is raised. As a result, in a case where the temperature of the specific resin particles is low, the specific resin particles are likely to have the properties of a viscous material, and as the temperature of the specific resin particles is raised, the specific resin particles are more likely to have the properties of an elastic material. Consequently, the crystalline resin and the binder resin are likely to be further inhibited from being compatible with each other, and the smoothing of the image surface is likely to be further suppressed.

The specific resin particles are, for example, preferably crosslinked resin particles.

“Crosslinked resin particles” refer to resin particles having a bridging structure between specific atoms in the polymer structure contained in the resin particles.

In a case where the crosslinked resin particles are used as the specific resin particles, the loss coefficient tan δS (50) at 50° C. of the specific resin particles is more likely to be less than 1. As a result, it is easier to obtain an electrostatic charge image developing toner may further suppress gloss unevenness that may occur after the temperature of an image is raised.

Examples of the crosslinked resin particles include crosslinked resin particles crosslinked by ionic bonds (ionically crosslinked resin particles), crosslinked resin particles crosslinked by covalent bonds (covalently crosslinked resin particles), and the like. As the crosslinked resin particles, among these, for example, crosslinked resin particles crosslinked by covalent bonds are preferable.

The types of resin used for the crosslinked resin particles include a polyolefin-based resin (such as polyethylene or polypropylene), a styrene-based resin (such as polystyrene or α-polymethylstyrene), a (meth)acrylic resin (such as polymethyl methacrylate or polyacrylonitrile), an epoxy resin, a polyurethane resin, a polyurea resin, a polyamide resin, a polycarbonate resin, a polyether resin, a polyester resin, and copolymer resins of these. As necessary, each of these resins may be used alone, or two or more of these resins may be used in combination.

As the resin used for the crosslinked resin particles, among the above resins, for example, a styrene-(meth)acrylic copolymer resin is preferable.

That is, as the crosslinked resin particles, for example, styrene-(meth)acrylic copolymer resin particles are preferable.

In a case where the styrene-(meth)acrylic copolymer resin particles are used as the crosslinked resin particles, the resin particles are more likely to have a loss coefficient tan δS (30) at 30° C. of 1 or more and a loss coefficient tan δS (50) at 50° C. of less than 1. As a result, it is easier to obtain an electrostatic charge image developing toner may further suppress gloss unevenness that may occur after the temperature of an image is raised.

Examples of the styrene-(meth)acrylic copolymer resin include resins obtained by polymerizing the following styrene-based monomer and (meth)acrylic monomer by radical polymerization.

Examples of the styrene-based monomer include styrene, α-methylstyrene, vinylnaphthalene, alkyl-substituted styrene having an alkyl chain, such as 2-methylstyrene, 3-methylstyrene, 4-methylstyrene, 2-ethylstyrene, 3-ethylstyrene, and 4-ethylstyrene, halogen-substituted styrene such as 2-chlorostyrene, 3-chlorostyrene, and 4-chlorostyrene, fluorine-substituted styrene such as 4-fluorostyrene and 2,5-difluorostyrene, and the like. Among these, for example, styrene and α-methylstyrene are preferable.

Examples of the (meth)acrylic monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isopentyl (meth)acrylate, isooctyl (meth)acrylate, 2-ethylhexyl (meth)acrylate, phenyl (meth)acrylate, biphenyl (meth)acrylate, diphenyl ethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, (meth)acrylonitrile, (meth)acrylamide, and the like. Among these, for example, n-butyl (meth)acrylate and β-carboxyethyl (meth)acrylate are preferable.

Examples of crosslinking agents for crosslinking the resin in the crosslinked resin particles include aromatic polyvinyl compounds such as divinylbenzene and divinylnaphthalene; polyvinyl esters of aromatic polyvalent carboxylic acids, such as divinyl phthalate, divinyl isophthalate, divinyl terephthalate, divinyl homophthalate, divinyl trimesate, trivinyl trimesate, divinyl naphthalenedicarboxylate, and divinyl biphenylcarboxylate; divinyl esters of nitrogen-containing aromatic compounds, such as divinyl pyridine dicarboxylate; vinyl esters of unsaturated heterocyclic compound carboxylic acid, such as vinyl pyromucate, vinyl furan carboxylate, vinyl pyrrole-2-carboxylate, and vinyl thiophene carboxylate; (meth)acrylic acid esters of linear polyhydric alcohols, such butanediol methacrylate, hexanediol acrylate, octanediol methacrylate, decanediol acrylate, and dodecanediol methacrylate; (meth)acrylic acid esters of branched substituted polyhydric alcohols, such as neopentylglycol dimethacrylate and 2-hydroxy-1,3-diacryloxypropane; polyvinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetone dicarboxylate, divinyl glutarate, 3,3′-divinylthiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate, and the like. One kind of crosslinking agent may be used alone, or two or more kinds crosslinking agents may be used in combination.

The dispersion diameter of the specific resin particles is preferably, for example, 50 nm or more and 500 nm or less.

In a case where the dispersion diameter of the specific resin particles is within the above numerical range, the dispersibility of the specific resin particles in the toner particles is likely to be improved. The improvement of the dispersibility of the specific resin particles makes it easier for the crystalline resin and the resin particles in the toner particles to be close to each other, and is likely to lead to the improvement of the effect of suppressing smoothing of the image surface.

The dispersion diameter of the specific resin particles is, for example, more preferably 80 nm or more and 400 nm or less, and even more preferably 100 nm or more and 300 nm or less.

The dispersion diameter of the specific resin particles is a value measured using a transmission electron microscope (TEM).

As the transmission electron microscope, for example, JEM-2100p1 us manufactured by JEOL Ltd. can be used.

Hereinafter, a method for measuring the dispersion diameter of the specific resin particles will be specifically described.

The toner particles are cut in a thickness of about 0.1 μm with a microtome. The cross section of the toner particles is imaged at 10,000× magnification by using a transmission electron microscope, equivalent circular diameters of 100 resin particles dispersed in the toner particles are calculated based on the cross-sectional areas of the particles, and an arithmetic mean thereof is calculated and adopted as the dispersion diameter.

The content of the specific resin particles with respect to the total mass of the electrostatic charge image developing toner is, for example, preferably 1% by mass or more and 30% by mass or less, more preferably 2% by mass or more and 25% by mass or less, and even more preferably 3% by mass or more and 20% by mass or less.

In a case where the content of the specific resin particles is 1% by mass or more with respect to the total mass of the electrostatic charge image developing toner, the content of the specific resin particles in the toner particles is sufficient, which improves the effect of inhibiting the crystalline resin and the binder resin from being compatible with each other.

In a case where the content of the specific resin particles is 30% by mass or less with respect to the total mass of the electrostatic charge image developing toner, the content of the specific resin particles does not increase too much, which reduces the influence of roughness of the image surface on the gloss of the image, the roughness resulting from a high content of the specific resin particles.

Accordingly, the toner may be more likely to excellently suppress gloss unevenness that may occur after the temperature of an image is raised.

Relationship between binder resin and specific resin particles

Ratio between loss coefficients of crystalline resin and specific resin particles

In a case where tan δC (30) represents a loss coefficient of the crystalline resin at 30° C. and tan δC (50) represents a loss coefficient of the crystalline resin at 50° C., a ratio of the loss coefficient tan δS (30) to the loss coefficient tan δC (30) (tan δS (30)/tan δC (30)) is, for example, preferably 20.0 or more and 60.0 or less, and a ratio of the loss coefficient tan δS (50) to the loss coefficient tan δC (50) (tan δS (50)/tan δC (50)) is, for example, preferably 2.0 or more and 20.0 or less.

In a case where the ratio between loss coefficients of the crystalline resin and the resin particles is within the above numerical range, the affinity between the crystalline resin and the specific resin particles is likely to be further improved. Therefore, the resin particles and the crystalline resin are more likely to stay close to each other in an image, and the effect of suppressing smoothing of the image surface is likely to be further improved.

The ratio (tan δS (30)/tan δC (30)) is, for example, more preferably 22.0 or more and 55.0 or less, and even more preferably 25.0 or more and 50.0 or less.

The ratio (tan δS (50)/tan δC (50)) is, for example, more preferably 2.5 or more and 15.0 or less, and even more preferably 3.0 or more and 10.0 or less.

The loss coefficient of the crystalline resin is a value measured using a rheometer.

As the rheometer, for example, “ARES-G2 (trade name)” manufactured by TA Instruments LTD can be used.

The procedure for measuring the loss coefficient of the crystalline resin will be specifically described.

By using a resin of the same composition as the crystalline resin as a measurement target to be incorporated into the toner particles, a disk-shaped sample having a thickness of 1 mm and a diameter of 8 mm is prepared. By using the obtained disk-shaped sample, the loss coefficient is measured by the same procedure as the loss coefficient of the specific resin particles.

The loss coefficient of the disk-shaped sample measured at 30° C. is adopted as a loss coefficient tan δC (30), and the loss coefficient of the disk-shaped sample measured at 50° C. is adopted as a loss coefficient tan δC (50).

A ratio (S/C) of a content S of the specific resin particles to the content C of the crystalline resin is, for example, preferably 0.05 or more and 5.0 or less, more preferably 0.2 or more and 4.0 or less, and even more preferably 0.5 or more and 3.0 or less, based on mass.

In a case where the ratio (S/C) is 0.05 or more, the content of the specific resin particles with respect to the crystalline resin is sufficient, which improves the effect of inhibiting the crystalline resin and the binder resin from being compatible with each other.

In a case where the ratio (S/C) is 5.0 or less, the content of the specific resin particles with respect to the crystalline resin does not increase too much, which reduces the influence of roughness of the image surface on the gloss of the image, the roughness resulting from a high content of the specific resin particles.

Accordingly, the toner may be more likely to excellently suppress gloss unevenness that may occur after the temperature of an image is raised.

A difference between an SP value (S) as a solubility parameter of the specific resin particles and an SP value (R) as a solubility parameter of the binder resin (SP value (S)−SP value (R)) is, for example, preferably −1.0 or more and 1.0 or less.

In a case where the difference (SP value (S)−SP value (R)) is −1.0 or more and 1.0 or less, the dispersibility of the specific resin particles in the toner particles is likely to be improved. The improvement of the dispersibility of the specific resin particles makes it easier for the crystalline resin and the resin particles in the toner particles to be close to each other, and is likely to lead to the improvement of the effect of suppressing smoothing of the image surface.

The difference (SP value (S)−SP value (R)) is, for example, more preferably −0.9 or more and 0.9 or less, and even more preferably −0.8 or more and 0.8 or less.

A difference between the SP value (S) as a solubility parameter of the specific resin particles and an SP value (C) as a solubility parameter of the crystalline resin (SP value (S)−SP value (C)) is, for example, preferably 0 or more and 2.0 or less.

In a case where the difference (SP value (S)−SP value (C)) is 0 or more and 2.0 or less, the affinity between the crystalline resin and the specific resin particles is likely to be further improved. Therefore, the resin particles and the crystalline resin are more likely to stay close to each other in an image, and the effect of suppressing smoothing of the image surface is likely to be further improved.

The difference (SP value (S)−SP value (C)) is, for example, more preferably 0 or more and 1.8 or less, and even more preferably 0 or more and 1.5 or less.

From the viewpoint of improving the effect of suppressing gloss unevenness that may occur after the temperature of an image is raised, the SP value (S) as a solubility parameter of the specific resin particles is, for example, preferably 7.0 or more and 14.0 or less, more preferably 8.0 or more and 12.0 or less, and even more preferably 9.0 or more and 11.0 or less.

The SP value (S) as a solubility parameter of the specific resin particles, the SP value (R) as a solubility parameter of the binder resin, and the SP value (C) as a solubility parameter of the crystalline resin (unit: (cal/cm³)^{1/2}) are calculated by the Fedors' method. Specifically, the SP values are calculated by the following equation.

SP value=√(Ev/v)=√(ΣΔei/ΣΔvi) Equation:

(In the equation, Ev: evaporation energy (cal/mol), v: molar volume (cm³/mol), Dei: evaporation energy of each atom or atomic group, Δvi: molar volume of each atom or atomic group)

Details of this calculation method are described in Polym. Eng. Sci., Vol. 14, p. 147 (1974), Junji Mukai et al., “Practical Polymers for Engineers”, p. 66 (Kodansha, 1981), Polymer Handbook (4th Edition, Wiley-interscience Publication), and the like. The same method as described in these documents can also be used in the present exemplary embodiment.

In the present exemplary embodiment, (cal/cm³)^{1/2} is adopted as the unit of the SP value. In the present specification, the SP value is dimensionlessly written without the unit according to the custom.

Colorant

Examples of colorants include various pigments such as carbon black, chrome yellow, Hansa yellow, benzine yellow, indanthrene yellow, quinoline yellow, pigment yellow, permanent orange GTR, pyrazolone orange, vulcan orange, watch young red, permanent red, brilliant carmine 3B, brilliant carmine 6B, Dupont oil red, pyrazolone red, lithol red, rhodamine B lake, lake red C, pigment red, rose bengal, aniline blue, ultra marine blue, calco oil blue, methylene blue chloride, phthalocyanine blue, pigment blue, phthalocyanine green, and malachite green oxalate, various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye, and the like.

One kind of colorant may be used alone, or two or more of kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total mass of the toner particles is, for example, preferably 1% by mass or more and 30% by mass or less, and more preferably 3% by mass or more and 15% by mass or less.

Release Agent

Examples of the release agent include hydrocarbon-based wax; natural wax such as carnauba wax, rice wax, and candelilla wax; synthetic or mineral⋅petroleum-based wax such as montan wax; ester-based wax such as fatty acid esters and montanic acid esters; and the like. The release agent is not limited to these.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total mass of the toner particles is, for example, preferably 1% by mass or more and 20% by mass or less, and more preferably 3% by mass or more and 15% by mass or less.

Other Additives

Examples of other additives include well-known additives such as a magnetic material, a charge control agent, and inorganic powder. These additives are incorporated into the toner particles as internal additives.

Characteristics of Toner Particles and the Like

The toner particles may be, for example, toner particles that have a single-layer structure or toner particles having a so-called core shell structure that is configured with a core portion (core particle) and a coating layer (shell layer) covering the core portion.

The toner particles having a core-shell structure is, for example, preferably configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 3 μm or more and 8 μm or less.

The various average particle sizes and various particle size distribution indexes of the toner particles are measured using COULTER MULTISIZER III (manufactured by Beckman Coulter Inc.) and using ISOTON-II (manufactured by Beckman Coulter Inc.) as an electrolytic solution.

For measurement, a measurement sample in an amount of 0.5 mg or more and 50 mg or less is added to 2 ml of a 5% aqueous solution of a surfactant (preferably sodium alkylbenzene sulfonate, for example) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

For the particle size range (channel) divided based on the measured particle size distribution, a cumulative volume distribution and a cumulative number distribution are drawn from small-sized particles. The particle size at which the cumulative proportion of particles is 16% is defined as volume-based particle size D16v and a number-based particle size D16p. The particle size at which the cumulative proportion of particles is 50% is defined as volume-average particle size D50v and a cumulative number-average particle size D50p. The particle size at which the cumulative proportion of particles is 84% is defined as volume-based particle size D84v and a number-based particle size D84p.

By using these, a volume-average particle size distribution index (GSDv) is calculated as (D84v/D16v)^{1/2}, and a number-average particle size distribution index (GSDp) is calculated as (D84p/D16p)^{1/2}.

The average circularity of the toner particles is, for example, preferably 0.94 or more and 1.00 or less, and more preferably 0.95 or more and 0.99 or less.

The average circularity of the toner particles is determined by (circular equivalent perimeter)/(perimeter) [(perimeter of circle having the same projected area as particle image)/(perimeter of projected particle image)] Specifically, the average circularity is a value measured by the following method.

First, toner particles as a measurement target are collected by suction, and a flat flow of the particles is formed. Then, an instant flash of strobe light is emitted to the particles, and the particles are imaged as a still image. By using a flow-type particle image analyzer (FPIA-3000 manufactured by Spectris.) performing image analysis on the particle image, the average circularity is determined. The number of samplings for obtaining the average circularity is 4,500.

In a case where a toner contains external additives, the toner (developer) as a measurement target is dispersed in water containing a surfactant, then the dispersion is treated with ultrasonic waves so that the external additives are removed, and the toner particles are collected.

External Additive

The toner may contain external additives as necessary.

Examples of the external additives include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂.O₃.2SiO₂, CaCO₃, MgCO₃, BaSO₄, MgSO₄, and the like.

The surface of the inorganic particles as an external additive may have undergone a hydrophobizing treatment. The hydrophobizing treatment is performed, for example, by immersing the inorganic particles in a hydrophobing agent. The hydrophobing agent is not particularly limited, and examples thereof include a silane-based coupling agent, silicone oil, a titanate-based coupling agent, an aluminum-based coupling agent, and the like. One kind of each of these agents may be used alone, or two or more kinds of these agents may be used in combination.

Usually, the amount of the hydrophobing agent is, for example, 1 part by mass or more and 60 parts by mass or less with respect to 100 parts by mass of the inorganic particles.

Examples of external additives also include resin particles (resin particles such as polystyrene, polymethylmethacrylate (PMMA), and melamine resins), a cleaning activator (for example, a metal salt of a higher fatty acid represented by zinc stearate or fluorine-based polymer particles), and the like.

The amount of the external additives added to the exterior of the toner particles with respect to the toner particles is, for example, preferably 0.01% by mass or more and 10% by mass or less, and more preferably 0.01% by mass or more and 8.0% by mass or less.

Characteristics of Toner

The toner according to the present exemplary embodiment yields a gloss rate of change of an image of 0% or more and 10.0% or less before and after heating the image at 50° C. for 30 days, the image being a 25 mm×25 mm square image formed at a toner application amount of 13.5 g/m².

From the viewpoint of further suppressing smoothing of the image surface, for example, the gloss rate of change of the image before and after heating the image at 50° C. for 30 days is, for example, preferably 0% or more and 9.0% or less, more preferably 0% or more 8.0% or less, and even more preferably 0% or more and 5.0% or less.

The procedure for measuring the gloss rate of change will be specifically described below.

By using an image forming apparatus (for example, ApeosPort C4570 manufactured by FUJIFILM Business Innovation Corp.), a 25 mm×25 mm square image at a toner application amount of 13.5 g/m² is formed on 10 sheets of coated paper (MIRRORKOTE PLATINUM PAPER manufactured by Oji Paper Co., Ltd., paper density of 256 g/m²)

At four corners (upper right corner, lower right corner, upper left corner, and lower left corner) and the central part of each of the obtained images, 60° gloss is measured using a glossmeter. For the measured 50 values of gloss, an arithmetic mean is calculated and adopted as “gloss of image before heating”.

Subsequently, the paper on which the image is formed is put in a thermohygrostat chamber with an internal temperature of 50° C. and a humidity of 20%, and heated for 30 days.

After heating, at four corners (upper right corner, lower right corner, upper left corner, and lower left corner) and the central part of each of the images, 60° gloss is measured using a glossmeter. For the measured 50 values of gloss, an arithmetic mean is calculated and adopted as “gloss of image after heating”.

The gloss rate of change determined from the difference between “gloss of image before heating” and “gloss of image after heating” ({“gloss of image before heating”−“gloss of image after heating”}/gloss of image before heating×100) is adopted as a gloss rate of change of the image before and after heating.

As the aforementioned glossmeter, for example, it is possible to use a portable glossmeter (BYK GARDNER MICRO-TRI-GLOSS, manufactured by Toyo Seiki Seisaku-sho, Ltd.).

Manufacturing Method of Toner

Next, the manufacturing method of the toner according to the present exemplary embodiment will be described.

The toner according to the present exemplary embodiment is obtained by manufacturing toner particles and then adding external additives to the exterior of the toner particles as necessary.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). The manufacturing method of the toner particles is not particularly limited to these manufacturing methods, and a well-known manufacturing method is adopted.

Among the above methods, for example, the aggregation and coalescence method is preferably used for obtaining toner particles.

Specifically, for example, in a case where the toner particles are manufactured by the aggregation and coalescence method, the toner particles are manufactured through a step of preparing a resin particle dispersion in which resin particles to be a binder resin are dispersed and a specific resin particle dispersion to be specific resin particles (a resin particle dispersion-preparing step), a step of allowing the resin particles (plus other particles as necessary) to be aggregated in the resin particle dispersion (having been mixed with another resin particle dispersion as necessary) so as to form aggregated particles (aggregated particle forming step), and a step of heating an aggregated particle dispersion in which the aggregated particles are dispersed so as to allow the aggregated particles to undergo fusion⋅coalescence and to form toner particles (fusion⋅coalescence step).

Hereinafter, each of the steps will be specifically described.

In the following section, a method for obtaining toner particles containing a colorant and a release agent will be described. The colorant and the release agent are used as necessary. It goes without saying that other additives different from the colorant and the release agent may also be used.

Resin Particle Dispersion-Preparing Step

First, for example, a colorant particle dispersion in which colorant particles are dispersed and a release agent particle dispersion in which release agent particles are dispersed are prepared together with the resin particle dispersion in which resin particles to be a binder resin are dispersed.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of these media may be used alone, or two or more kinds of these media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, for example, an anionic surfactant and a cationic surfactant are particularly preferable. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (0 phase) for causing neutralization, and then adding an aqueous medium (W phase), so that the resin undergoes conversion (so-called phase transition) from W/O to O/W, turns into a continuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and even more preferably 0.1 μm or more and 0.6 μm or less.

For determining the volume-average particle size of the resin particles, a particle size distribution is measured using a laser waveform-type particle size distribution analyzer (for example, LS-13.320 manufactured by Beckman Coulter, Inc.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, a colorant particle dispersion and a release agent particle dispersion are prepared in the same manner as the resin particle dispersion. That is, the volume-average particle size of particles, the dispersion medium, the dispersion method, and the particle content in the resin particle dispersion are also applied to the colorant particles to be dispersed in the colorant particle dispersion and the release agent particles to be dispersed in the release agent particle dispersion.

Preparation of Specific Resin Particle Dispersion

As a method for preparing the specific resin particle dispersion, for example, known methods such as an emulsion polymerization method, a melt kneading method using a Banbury mixer or a kneader, a suspension polymerization method, and a spray drying method are used. Among these, for example, an emulsion polymerization method is preferable.

From the viewpoint of making the loss coefficient fall into the preferable range, for example, it is preferable to use a styrene-based monomer and a (meth)acrylic monomer as monomers and polymerize these in the presence of a crosslinking agent.

Furthermore, in manufacturing the specific resin particles, for example, it is preferable to perform emulsion polymerization a plurality of times.

Hereinafter, a method for manufacturing the specific resin particles will be specifically described.

The method for preparing the specific resin particle dispersion preferably includes, for example,

a step of obtaining an emulsion containing a monomer, a crosslinking agent, a surfactant, and water (emulsion preparation step),

a step of adding a polymerization initiator to the emulsion and heating the emulsion so as to polymerize the monomer (first emulsion polymerization step), and

a step of adding an emulsion containing a monomer to a reaction solution obtained after the first emulsion polymerization step and heating the solution so as to polymerize the monomer (second emulsion polymerization step).

In a case where a styrene-based monomer and a (meth)acrylic monomer are used as monomers, by adjusting the proportion of the styrene-based monomer in the monomers contained in the reaction solution in the first emulsion polymerization step and adjusting the proportion of the styrene-based monomer in the monomers added in the second emulsion polymerization step in consideration of difference in reactivity, it is possible to vary the way the molecules form a chain or the way the resin is crosslinked.

In a case where the proportion of the monomers is adjusted as described above, the glass transition temperature is likely to be high on the inside of the specific resin particles but low in the vicinity of the surface of the specific resin particles. The way the molecules form a chain or the way the resin is crosslinked can also be varied by the polymerization temperature, the amount of the polymerization initiator added, the method of adding the polymerization initiator, the speed of dropwise addition of the emulsion, the amount of the crosslinking agent added, and the like set in consideration of the reactivity of the monomers, in addition to adjusting the proportion of the monomers. In a case where these methods are used, it is easy to obtain resin particles having the loss coefficient tan δS (30) at 30° C. of 1 or more and the loss coefficient tan δS (50) at 50° C. of less than 1.

Emulsion Preparation Step

This is a step of obtaining an emulsion containing a monomer, a crosslinking agent, a surfactant, and water.

Although the method for obtaining the emulsion is not particularly limited, it is preferable to obtain the emulsion by emulsifying a monomer, a crosslinking agent, a surfactant, and water by using an emulsifying machine.

Examples of the emulsifying machine include a rotary stirrer equipped with a propeller type, anchor type, paddle type, or turbine type stirring blade, a stationary mixer such as a static mixer, and a rotor⋅stator type emulsifying machine such as a homogenizer or Clare mix, a mill type emulsifying machine having grinding function, a high-pressure emulsifying machine such as a Munton Gorlin-type pressure emulsifying machine, a high-pressure nozzle type emulsifying machine that causes cavitation under high pressure, a high-pressure impact-type emulsifying machine, such as a microfluidizer, which generates shearing force by causing collision of liquids under high pressure, an ultrasonic emulsifying machine that causes cavitation by using ultrasonic waves, a membrane emulsifying machine that performs uniform emulsification through pores, and the like.

As the monomers, for example, it is preferable to use a styrene-based monomer and a (meth)acrylic monomer.

As the crosslinking agent, the aforementioned crosslinking agent is used.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. The nonionic surfactant may be used in combination with an anionic surfactant or a cationic surfactant. Among these, an anionic surfactant is preferable, for example. One kind of surfactant may be used alone, or two or more kinds of surfactants may be used in combination.

The emulsion may contain a chain transfer agent. The chain transfer agent is not particularly limited. As the chain transfer agent, a compound having a thiol component can be used. Specifically, for example, alkyl mercaptans such as hexyl mercaptan, heptyl mercaptan, octyl mercaptan, nonyl mercaptan, decyl mercaptan, and dodecyl mercaptan are preferable.

First Emulsion Polymerization Step

This is a step of adding a polymerization initiator to the emulsion and heating the emulsion so as to polymerize the monomers.

In polymerizing the monomers, for example, it is preferable to stir the emulsion (reaction solution) containing the polymerization initiator with a stirrer.

Examples of the stirrer include a rotary stirrer equipped with a propeller type, anchor type, paddle type, or turbine type stirring blade.

As the polymerization initiator, for example, it is preferable to use ammonium persulfate.

Second Emulsion Polymerization Step

This is a step of adding an emulsion containing monomers to the reaction solution obtained after the first emulsion polymerization step and heating the reaction solution so as to polymerize the monomers.

In polymerizing the monomers, for example, it is preferable to stir the reaction solution as in the first emulsion polymerization step.

For example, it is preferable to obtain the emulsion containing monomers by emulsifying monomers, a surfactant, and water by using an emulsifying machine.

Aggregated Particle Forming Step

Next, the resin particle dispersion is mixed with the colorant particle dispersion, the release agent particle dispersion, and the specific resin particle dispersion.

Then, in the mixed dispersion, the resin particles, the colorant particles, the release agent particles, and the specific resin particles are hetero-aggregated so that aggregated particles are formed which have a diameter close to the diameter of the target toner particles and include the resin particles, the colorant particles, the release agent particles, and the specific resin particles.

Specifically, for example, an aggregating agent is added to the mixed dispersion, the pH of the mixed dispersion is adjusted so that the dispersion is acidic (for example, pH of 2 or higher and 5 or lower), and a dispersion stabilizer is added thereto as necessary. Then, the dispersion is heated to the glass transition temperature of the resin particles (specifically, for example, to a temperature equal to or higher than the glass transition temperature of the resin particles—30° C. and equal to or lower than the glass transition temperature of the resin particles—10° C.) so that the particles dispersed in the mixed dispersion are aggregated, thereby forming aggregated particles.

In the aggregated particle forming step, for example, in a state where the mixed dispersion is being stirred with a rotary shearing homogenizer, an aggregating agent may be added thereto at room temperature (for example, 25° C.), the pH of the mixed dispersion may be adjusted so that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. Particularly, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; inorganic metal salt polymers such as polyaluminum chloride, polyaluminum hydroxide, and calcium polysulfide; and the like.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA), and the like.

The amount of the chelating agent added with respect to 100 parts by mass of resin particles is, for example, preferably 0.01 parts by mass or more and 5.0 parts by mass or less, and more preferably 0.1 parts by mass or more and less than 3.0 parts by mass.

Fusion⋅Coalescence Step

The aggregated particle dispersion in which the aggregated particles are dispersed is then heated to, for example, a temperature equal to or higher than the glass transition temperature of the resin particles (for example, a temperature higher than the glass transition temperature of the resin particles by 10° C. to 30° C.) so that the aggregated particles are fused and coalesce, thereby forming toner particles.

Toner particles are obtained through the above steps.

The toner particles may be manufactured through a step of obtaining an aggregated particle dispersion in which the aggregated particles are dispersed, then mixing the aggregated particle dispersion with a resin particle dispersion in which resin particles are dispersed so as to cause the resin particles to be aggregated and adhere to the surface of the aggregated particles and to form second aggregated particles, and a step of heating a second aggregated particle dispersion in which the second aggregated particles are dispersed so as to cause the second aggregated particles to be fused and coalesce and to form toner particles having a core/shell structure.

After the fusion⋅coalescence step, the toner particles formed in a solution undergo known washing step, solid-liquid separation step, and drying step, thereby obtaining dry toner particles.

As the washing step, in view of charging properties, for example, it is preferable to sufficiently perform displacement washing by using deionized water. The solid-liquid separation step is not particularly limited. However, in view of productivity, for example, it is preferable to perform suction filtration, pressure filtration, or the like. Furthermore, the method of the drying step is not particularly limited. However in view of productivity, for example, it is preferable to perform freeze drying, flush drying, fluidized drying, vibratory fluidized drying, or the like.

Then, for example, by adding an external additive to the obtained dry toner particles and mixing together the external additive and the toner particles, the toner according to the present exemplary embodiment are manufactured. The mixing may be performed, for example, using a V blender, a Henschel mixer, a Lödige mixer, or the like. Furthermore, coarse particles of the toner may be removed as necessary by using a vibratory sieving machine, a pneumatic sieving machine, or the like.

Electrostatic Charge Image Developer

The electrostatic charge image developer according to the present exemplary embodiment contains at least the toner according to the present exemplary embodiment.

The electrostatic charge image developer according to the present exemplary embodiment may be a one-component developer which contains only the toner according to the present exemplary embodiment or a two-component developer which is obtained by mixing together the toner and a carrier.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; a resin impregnation-type carrier obtained by impregnating porous magnetic powder with a resin; and the like.

Each of the magnetic powder dispersion-type carrier and the resin impregnation-type carrier may be a carrier obtained by coating a core material, which is particles configuring the carrier, with a coating resin.

Examples of the magnetic powder include magnetic metals such as iron, nickel, and cobalt; magnetic oxides such as ferrite and magnetite; and the like.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, a straight silicone resin configured with an organosiloxane bond, a product obtained by modifying the straight silicone resin, a fluororesin, polyester, polycarbonate, a phenol resin, an epoxy resin, and the like.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, which are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; a kneader coater method of mixing the core material of the carrier with the solution for forming a coating layer in a kneader coater and removing solvents; and the like.

The mixing ratio (mass ratio) between the toner and the carrier, represented by toner:carrier, in the two-component developer is, for example, preferably 1:100 to 30:100, and more preferably 3:100 to 20:100.

Image Forming Apparatus/Image Forming Method

The image forming apparatus/image forming method according to the present exemplary embodiment will be described.

The image forming apparatus according to the present exemplary embodiment includes an image holder, a charging unit that charges the surface of the image holder, an electrostatic charge image forming unit that forms an electrostatic charge image on the charged surface of the image holder, a developing unit that contains an electrostatic charge image developer and develops the electrostatic charge image formed on the surface of the image holder as a toner image by using the electrostatic charge image developer, a transfer unit that transfers the toner image formed on the surface of the image holder to the surface of a recording medium, and a fixing unit that fixes the toner image transferred to the surface of the recording medium. As the electrostatic charge image developer, the electrostatic charge image developer according to the present exemplary embodiment is used.

In the image forming apparatus according to the present exemplary embodiment, an image forming method (image forming method according to the present exemplary embodiment) is performed which has a charging step of charging the surface of the image holder, an electrostatic charge image forming step of forming an electrostatic charge image on the charged surface of the image holder, a developing step of developing the electrostatic charge image formed on the surface of the image holder as a toner image by using the electrostatic charge image developer according to the present exemplary embodiment, a transfer step of transferring the toner image formed on the surface of the image holder to the surface of a recording medium, and a fixing step of fixing the toner image transferred to the surface of the recording medium.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge neutralizing unit that neutralizes charge by irradiating the surface of the image holder with charge neutralizing light before charging after the transfer of the toner image.

In the case of the inter transfer-type apparatus, as the transfer unit, for example, a configuration is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In the image forming apparatus according to the present exemplary embodiment, for example, a portion including the developing unit may be a cartridge structure (process cartridge) to be attached to and detached from the image forming apparatus. As the process cartridge, for example, a process cartridge is suitably used which includes a developing unit that contains the electrostatic charge image developer according to the present exemplary embodiment.

An example of the image forming apparatus according to the present exemplary embodiment will be shown below, but the present invention is not limited thereto. Hereinafter, among the parts shown in the drawing, main parts will be described, and others will not be described.

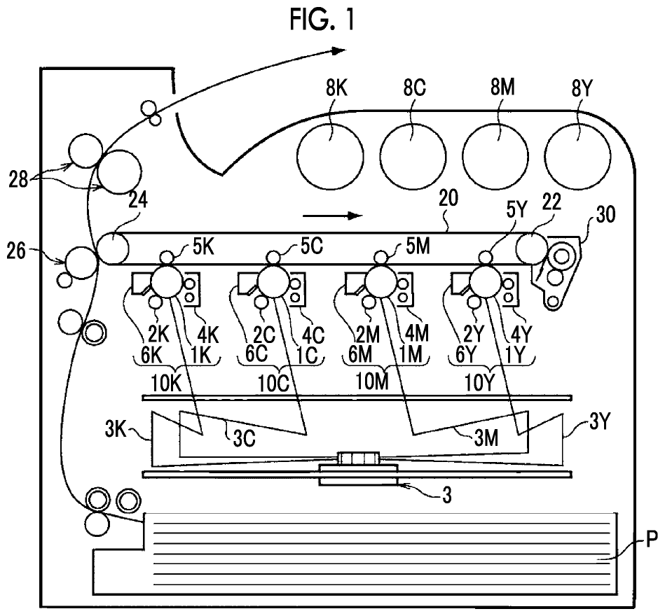

FIG. 1 is a view schematically showing the configuration of the image forming apparatus according to the present exemplary embodiment.

The image forming apparatus shown in FIG. 1 includes first to fourth image forming units 10Y, 10M, 10C, and 10K (image forming means) adopting an electrophotographic method that output images of colors, yellow (Y), magenta (M), cyan (C), and black (K), based on color-separated image data. These image forming units (hereinafter, simply called “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 which is in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the surface of the intermediate transfer belt 20 on the image holder side.

Toners including toners of four colors, yellow, magenta, cyan, and black, stored in toner cartridges 8Y, 8M, 8C, and 8K are supplied to developing devices (developing units) 4Y, 4M, 4C, and 4K of units 10Y, 10M, 10C, and 10K, respectively.

The first to fourth units 10Y, 10M, 10C, and 10K have the same configuration. Therefore, in the present specification, as a representative, the first unit 10Y will be described which is placed on the upstream side of the running direction of the intermediate transfer belt and forms a yellow image. Reference numerals marked with magenta (M), cyan (C), and black (K) instead of yellow (Y) are assigned in the same portions as these in the first unit 10Y, so that the second to fourth units 10M, 10C, and 10K will not be described again.

The first unit 10Y has a photoreceptor 1Y that acts as an image holder. Around the photoreceptor 1Y, a charging roll 2Y (an example of charging unit) that charges the surface of the photoreceptor 1Y at a predetermined potential, an exposure device 3 (an example of electrostatic charge image forming unit) that exposes the charged surface to a laser beam 3Y based on color-separated image signals so as to form an electrostatic charge image, a developing device 4Y (an example of developing unit) that develops the electrostatic charge image by supplying a charged toner to the electrostatic charge image, a primary transfer roll 5Y (an example of primary transfer unit) that transfers the developed toner image onto the intermediate transfer belt 20, and a photoreceptor cleaning device 6Y (an example of cleaning unit) that removes the residual toner on the surface of the photoreceptor 1Y after the primary transfer are arranged in this order.

The primary transfer roll 5y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ωcm or less) substrate. The photosensitive layer has properties in that although this layer usually has a high resistance (resistance of a general resin), in a case where it is irradiated with the laser beam 3Y, the resistivity of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y. As a result, an electrostatic charge image of a yellow image pattern is formed on the surface of the photoreceptor 1Y.

The electrostatic charge image is an image formed on the surface of the photoreceptor 1Y by charging. It is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y is rotated to a predetermined development position as the photoreceptor 1Y runs. At the development position, the electrostatic charge image on the photoreceptor 1Y turns in to visible image (developed image) as a toner image by the developing device 4Y.

The developing device 4Y contains, for example, an electrostatic charge image developer that contains at least a yellow toner and a carrier. By being stirred in the developing device 4Y, the yellow toner undergoes triboelectrification, carries charges of the same polarity (negative charge) as the charges with which the surface of the photoreceptor 1Y is charged, and is held on a developer roll (an example of a developer holder). Then, as the surface of the photoreceptor 1Y passes through the developing device 4Y, the yellow toner electrostatically adhere to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 μA under the control of the control unit (not shown in the drawing).

Meanwhile, the residual toner on the photoreceptor 1Y is removed by a photoreceptor cleaning device 6Y and collected.

Furthermore, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll 26 (an example of secondary transfer unit) disposed on the image holding surface side of the intermediate transfer belt 20. Meanwhile, via a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, which makes the toner image on the intermediate transfer belt 20 transferred onto the recording paper P. The secondary transfer bias to be applied at this time is determined according to the resistance detected by a resistance detecting unit (not shown in the drawing) for detecting the resistance of the secondary transfer unit, and the voltage thereof is controlled.

Then, the toner image is transported into a pressure contact portion (nip portion) of a pair of fixing rolls in the fixing device 28 (an example of fixing unit) and fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet and the like, in addition to the recording paper P.

In order to further improve the smoothness of the image surface after fixing, for example, it is preferable that the surface of the recording paper P be also smooth. For instance, coated paper prepared by coating the surface of plain paper with a resin or the like, art paper for printing, and the like are suitably used.

The recording paper P on which the color image has been fixed is transported to an output portion, and a series of color image forming operations is finished.

Process Cartridge/Toner Cartridge

The process cartridge according to the present exemplary embodiment will be described.

The process cartridge according to the present exemplary embodiment includes a developing unit which contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other units, such as an image holder, a charging unit, an electrostatic charge image forming unit, and a transfer unit, as necessary.

An example of the process cartridge according to the present exemplary embodiment will be shown below, but the present invention is not limited thereto. Hereinafter, among the parts shown in the drawing, main parts will be described, and others will not be described.

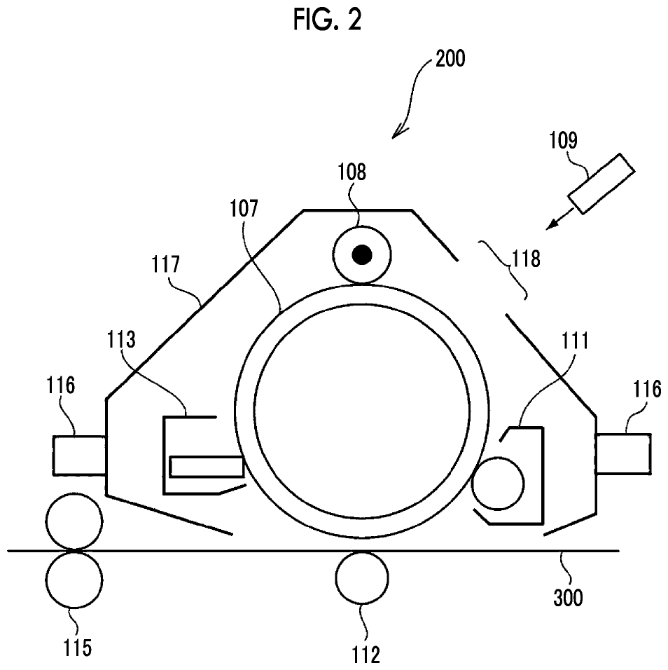

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging unit) that is provided on the periphery of the photoreceptor 107, a developing device 111 (an example of developing unit), a photoreceptor cleaning device 113 (an example of cleaning unit), which are integrally combined and held in the housing 117. The process cartridge 200 forms a cartridge in this way.

In FIG. 2, 109 represents an exposure device (an example of electrostatic charge image forming unit), 112 represents a transfer device (an example of transfer unit), 115 represents a fixing device (an example of fixing unit), and 300 represents recording paper (an example of recording medium).

Next, the toner cartridge according to the present exemplary embodiment will be described.

The toner cartridge according to the present exemplary embodiment is a toner cartridge including a container that contains the toner according to the present exemplary embodiment and is detachable from the image forming apparatus. The toner cartridge includes a container that contains a replenishing toner to be supplied to the developing unit provided in the image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In a case where the amount of the toner contained in the container of the toner cartridge is low, the toner cartridge is replaced.

### EXAMPLES

Examples will be described below, but the present invention is not limited to these examples. In the following description, unless otherwise specified, “parts” and “%” are based on mass in all cases.

Preparation of Amorphous Resin Particle Dispersion
Terephthalic acid 100 parts by mol
Ethylene oxide (2 mol) adduct of bisphenol A: 20 parts by mol
Propylene oxide (2 mol) adduct of bisphenol A: 80 parts by mol

The above materials are put in a reactor equipped with a stirrer, a nitrogen introduction tube, a temperature sensor, and a rectifying column, the temperature is raised to 190° C. for 1 hour, and dibutyltin oxide is added thereto in an amount of 1.2 parts with respect to 100 parts of the above materials. While the generated water is being distilled off, the temperature is raised to 240° C. for 6 hours, a dehydrocondensation reaction is continued for 3 hours in the reaction solution kept at 240° C., and then the reactant is cooled.

The molten reactant is transferred as it is to CAVITRON CD1010 (manufactured by Eurotech Ltd.) at a rate of 100 g/min. At the same time, separately prepared aqueous ammonia having a concentration of 0.37% by mass is transferred to CAVITRON CD1010 at a rate of 0.1 L/min in a state of being heated at 120° C. with a heat exchanger. CAVITRON CD1010 is operated under the conditions of a rotation speed of a rotor of 60 Hz and a pressure of 5 kg/cm², thereby obtaining a resin particle dispersion in which resin particles having a volume-average particle size of 160 nm. Deionized water is added to the resin particle dispersion, and the solid content thereof is adjusted to 30% by mass, thereby obtaining an amorphous resin particle dispersion.

Preparation of Crystalline Resin Particle Dispersion 1
1,10-Dodecanedioic acid: 225 parts by mass
1,9-Nonanediol: 174 parts by mass

The above materials are put in a reactor equipped with a stirrer, a nitrogen introduction tube, a temperature sensor, and a rectifying column, the temperature is raised to 160° C. for 1 hour, and 0.8 parts by mass of dibutyltin oxide is added thereto. While the generated water is being distilled off, the temperature is raised to 180° C. for 5 hours, a dehydrocondensation reaction is continued for 5 hours at a temperature kept at 180° C. Then, the temperature is slowly raised to 230° C. under reduced pressure (3 kPa), and the reaction solution is stirred for 2 hours in a state of being kept at 230° C. Thereafter, the reactant is cooled. After cooling, solid-liquid separation is performed, and the solids are dried, thereby obtaining a crystalline polyester resin.
Crystalline polyester resin: 100 parts
Methyl ethyl ketone: 40 parts
Isopropyl alcohol: 30 parts
10% aqueous ammonia solution: 6 parts The above materials are put in a 3 L jacketed reaction vessel (manufactured by EYELA: BJ-30N) equipped with a condenser, a thermometer, a water dripping device, and an anchor blade. In a state where the reaction vessel is being kept at 80° C. in a water circulation-type thermostatic bath, and the materials are being stirred and mixed together at 100 rpm, the resin is dissolved. Then, the water circulation-type thermostatic bath is set to 50° C., and a total of 400 parts of deionized water kept at 50° C. is added dropwise thereto at a rate of 7 parts by mass/min so that phase transition occurs, thereby obtaining an emulsion. The obtained emulsion (576 parts by mass) and 500 parts by mass of deionized water are put in a 2 L eggplant flask and set in an evaporator (manufactured by EYELA) equipped with a vacuum controlled unit via a trap ball. While being rotated, the eggplant flask is heated in a hot water bath at 60° C., and the pressure is reduced to 7 kPa with care to sudden boiling, thereby removing the solvent. At a point in time when the amount of solvent collected reaches 750 parts by mass, the pressure is returned to normal pressure, and the eggplant flask is cooled in water, thereby obtaining a dispersion. The volume-average particle size D50v of the resin particles in this dispersion is 130 nm. Then, deionized water is added thereto, thereby obtaining a crystalline resin particle dispersion 1 having a solid content concentration of 30% by mass.

Preparation of Crystalline Resin Particle Dispersion 2

A crystalline resin particle dispersion 2 is obtained in the same manner as in <Preparation of crystalline resin particle dispersion 1> described above, except that in <Preparation of crystalline resin particle dispersion 1>, a crystalline polyester resin is obtained by changing the procedure following the addition of dibutyltin oxide as described in the following “⋅What are changed”.

What are Changed

Dibutyltin oxide (0.8 parts by mass) is added, the temperature is then raised to 200° C. for 6 hours while the generated water is being distilled off, and a dehydrocondensation reaction is continued for 8 hours at a temperature kept at 200° C. Then, the temperature is slowly raised to 230° C. under reduced pressure (3 kPa), and the reaction solution is stirred for 2 hours in a state of being kept at 230° C. Thereafter, the reactant is cooled. After cooling, solid-liquid separation is performed, and the solids are dried, thereby obtaining a crystalline polyester resin.

Preparation of Crystalline Resin Particle Dispersion 3

A crystalline resin particle dispersion 3 is obtained in the same manner as in <Preparation of crystalline resin particle dispersion 1> described above, except that in <Preparation of crystalline resin particle dispersion 1>, as a material to be added to the reactor in the process of preparing the crystalline polyester resin, 100 parts by mass of terephthalic acid is added in addition to 1,10-dodecanedioic acid and 1,9-nonanediol.

Preparation of Crystalline Resin Particle Dispersion
1-Octadecene oxide: 242 parts by mass
1,10-Dodecanediol: 17 parts by mass

The above materials are put in a reactor equipped with a stirrer, a nitrogen introduction tube, a temperature sensor, and a rectifying column, heated to 150° C. under a nitrogen stream, and reacted for 4 hours. Potassium tert-butoxide (0.6 parts by mass) is added thereto, and the reaction is performed for 3 more hours. The obtained resin is cooled and then recrystallized twice over isopropyl alcohol, thereby obtaining a crystalline resin particle dispersion 4. The crystalline resin particle dispersion 4 is a crystalline resin particle dispersion containing a crystalline polyether resin.

Preparation of Crystalline Resin Particle Dispersion 5
Sebacic acid: 111 parts
Terephthalic acid 75 parts
1,6-Hexanediol: 118 parts

The above materials are put in a reactor equipped with a stirrer, a nitrogen introduction tube, a temperature sensor, and a rectifying column, the temperature is raised to 160° C. for 1 hour, 0.8 parts by mass of dibutyltin oxide is added thereto, and then the materials are reacted for 12 hours under a nitrogen stream. The reaction product is cooled and then recrystallized twice over isopropyl alcohol, thereby obtaining a crystalline resin particle dispersion 5.

Preparation of Crystalline Resin Particle Dispersion 6

A crystalline resin particle dispersion 6 is obtained in the same manner as in <Preparation of crystalline resin particle dispersion 5> described above, except that in <Preparation of crystalline resin particle dispersion 5>, the amount of sebacic acid added to the reactor is changed to 101 parts and the amount of terephthalic acid added to the reactor is changed to 83 parts.

Preparation of Crystalline Resin Particle Dispersion 7
1,12-Dodecanedicarboxylic acid: 225 parts by mass
1,9-Nonanediol: 174 parts by mass

The above materials are put in a reactor equipped with a stirrer, a nitrogen introduction tube, a temperature sensor, and a rectifying column, the temperature is raised to 160° C. for 1 hour, 0.8 parts by mass of dibutyltin oxide is added thereto, and then the materials are reacted for 12 hours under a nitrogen stream. The reaction product is cooled and then recrystallized twice over isopropyl alcohol, thereby obtaining a crystalline resin particle dispersion 7.

Preparation of Crystalline Resin Particle Dispersion 8

A crystalline resin particle dispersion 8 is obtained in the same manner as in <Preparation of crystalline resin particle dispersion 1> described above, except that in <Preparation of crystalline resin particle dispersion 1>, the hydrocondensation reaction time is changed to 10 hours.

Preparation of Specific Resin Particle Dispersion 1

Preparation of Emulsion 1-1
Styrene: 40 parts
n-Butyl acrylate: 60 parts
Divinylbenzene: 2.0 parts

The above materials are added to a mixing vessel equipped with a stirrer and stirred. A mixed solution of 1.5 parts of an anionic surfactant (DOWFAX 2a1 manufactured by The Dow Chemical Company) and 60 parts of deionized water is added to a mixing vessel and stirred, thereby obtaining an emulsion 1-1.

Preparation of Emulsion 1-2
Styrene: 600 parts
n-Butyl acrylate: 400 parts
Divinylbenzene: 20.0 parts

The above materials are added to a mixing vessel equipped with a stirrer and stirred. A mixed solution of 15 parts of an anionic surfactant (DOWFAX 2a1 manufactured by The Dow Chemical Company) and 2,000 parts of deionized water is added to a mixing vessel and stirred, thereby obtaining an emulsion 1-2.

Preparation of Specific Resin Particle Dispersion 1

An anionic surfactant (2.0 parts, DOWFAX manufactured by The Dow Chemical Company) and 90 parts of deionized water are added to a reactor equipped with a stirrer and a nitrogen introduction tube and stirred. The entirety of the emulsion 1-1 is added thereto, and 10 parts of ammonium persulfate having a concentration of 10% by mass is further added thereto.

The reactor is cleaned out by nitrogen purging, the reaction solution is heated in an oil bath while being stirred so that the temperature of the reaction solution (temperature of a first reaction solution) reaches 60° C. The reaction solution is stirred for 2 hours while being kept at the same temperature, thereby performing emulsion polymerization.

Then, the reaction solution is kept as it is for 1 hour, and 1 part of ammonium persulfate is added thereto. The emulsion 1-2 (1,000 parts) is added to the reactor, the reaction solution is heated in an oil bath while being stirred so that the temperature of the reaction solution reaches 75° C. Subsequently, the emulsion 1-2 is added thereto so that the total amount of the emulsion 1-2 added is ½ of the amount of the prepared emulsion 1-2 (that is, 1,510 parts in Preparation of specific resin particle dispersion 1), the temperature of the reaction solution is raised to 90° C., and emulsion polymerization is carried out by stirring the reaction solution for 3 hours in a state where the temperature of the reaction solution is being maintained, and then the reaction solution is cooled to room temperature. Deionized water is added thereto, thereby obtaining a specific resin particle dispersion 1 having a solid content concentration of 35% by mass.

Preparation of Specific Resin Particle Dispersion 2

A specific resin particle dispersion 2 is prepared by the same procedure as the specific resin particle dispersion 1, except that the emulsion 1-1 is changed to an emulsion 2-1 prepared by the procedure which will be described later, and the emulsion 1-2 is changed to an emulsion 2-2 prepared by the procedure which will be described later.

Preparation of Emulsion 2-1
Styrene: 30 parts
n-Butyl acrylate: 70 parts
Divinylbenzene: 2.0 parts

The above materials are added to a mixing vessel equipped with a stirrer and stirred. A mixed solution of 1.5 parts of an anionic surfactant (DOWFAX manufactured by The Dow Chemical Company) and 60 parts of deionized water is added to a mixing vessel and stirred, thereby obtaining an emulsion 2-1.

Preparation of Emulsion 2-2
Styrene: 300 parts
n-Butyl acrylate: 700 parts
Divinylbenzene: 20.0 parts

The above materials are added to a mixing vessel equipped with a stirrer and stirred. A mixed solution of 15 parts of an anionic surfactant (DOWFAX manufactured by The Dow Chemical Company) and 600 parts of deionized water is added to a mixing vessel and stirred, thereby obtaining an emulsion 2-2.

Preparation of Specific Resin Particle Dispersion 3

A specific resin particle dispersion 3 is prepared by the same procedure as the specific resin particle dispersion 1, except that the emulsion 1-1 is changed to an emulsion 3-1 prepared by the procedure which will be described later, and the emulsion 1-2 is changed to an emulsion 3-2 prepared by the procedure which will be described later.

Preparation of Emulsion 3-1
Styrene: 40 parts
n-Butyl acrylate: 60 parts
Divinylbenzene: 1.6 parts

The above materials are added to a mixing vessel equipped with a stirrer and stirred. A mixed solution of 1.5 parts of an anionic surfactant (DOWFAX manufactured by The Dow Chemical Company) and 60 parts of deionized water is added to a mixing vessel and stirred, thereby obtaining an emulsion 3-1.

Preparation of Emulsion 3-2
Styrene: 600 parts
n-Butyl acrylate: 400 parts
Divinylbenzene: 16.0 parts

The above materials are added to a mixing vessel equipped with a stirrer and stirred. A mixed solution of 15 parts of an anionic surfactant (DOWFAX manufactured by The Dow Chemical Company) and 600 parts of deionized water is added to a mixing vessel and stirred, thereby obtaining an emulsion 3-2.

Preparation of Specific Resin Particle Dispersion 4

Preparation of Emulsion 4-1
Styrene: 40 parts
n-Butyl acrylate: 60 parts
Divinylbenzene: 2.0 parts

The above materials are added to a mixing vessel equipped with a stirrer and stirred. A mixed solution of 1.5 parts of an anionic surfactant (DOWFAX manufactured by The Dow Chemical Company) and 60 parts of deionized water is added to a mixing vessel and stirred, thereby obtaining an emulsion 4-1.

Preparation of Emulsion 4-2
Styrene: 600 parts
n-Butyl acrylate: 400 parts
Divinylbenzene: 20.0 parts

The above materials are added to a mixing vessel equipped with a stirrer and stirred. A mixed solution of 15 parts of an anionic surfactant (DOWFAX manufactured by The Dow Chemical Company) and 600 parts of deionized water is added to a mixing vessel and stirred, thereby obtaining an emulsion 4-2.

Preparation of Specific Resin Particle Dispersion 4

An anionic surfactant (15.0 parts, DOWFAX manufactured by The Dow Chemical Company) and 90 parts of deionized water are added to a reactor equipped with a stirrer and a nitrogen introduction tube and stirred. The entirety of the emulsion 4-1 is added thereto, and 10 parts of ammonium persulfate having a concentration of 10% by mass is further added thereto.

The reactor is cleaned out by nitrogen purging, the reaction solution is heated in an oil bath while being stirred so that the temperature of the reaction solution reaches 75° C. The reaction solution is stirred for 2 hours while being kept at the same temperature, thereby performing emulsion polymerization.

Thereafter, 1,000 parts of the emulsion 4-2 is added to the reactor, the reaction solution is heated in an oil bath while being stirred so that the temperature of the reaction solution reaches 75° C., emulsion polymerization is carried out by stirring the reaction solution for 4 hours in a state where the temperature of the reaction solution is being maintained, and then the reaction solution is cooled to room temperature. Deionized water is added thereto, thereby obtaining a specific resin particle dispersion 4 having a solid content concentration of 35% by mass.

Preparation of Specific Resin Particle Dispersion 5

A specific resin particle dispersion 5 is prepared by the same procedure as the specific resin particle dispersion 4, except that the emulsion 4-1 is changed to an emulsion 5-1 prepared by the procedure which will be described later, and the emulsion 4-2 is changed to an emulsion 5-2 prepared by the procedure which will be described later.

Preparation of Emulsion 5-1
Styrene: 40 parts
n-Butyl acrylate: 60 parts
Divinylbenzene: 1.5 parts

The above materials are added to a mixing vessel equipped with a stirrer and stirred. A mixed solution of 1.5 parts of an anionic surfactant (DOWFAX manufactured by The Dow Chemical Company) and 60 parts of deionized water is added to a mixing vessel and stirred, thereby obtaining an emulsion 5-1.

Preparation of Emulsion 5-2
Styrene: 600 parts
n-Butyl acrylate: 400 parts
Divinylbenzene: 15.0 parts

The above materials are added to a mixing vessel equipped with a stirrer and stirred. A mixed solution of 15 parts of an anionic surfactant (DOWFAX manufactured by The Dow Chemical Company) and 600 parts of deionized water is added to a mixing vessel and stirred, thereby obtaining an emulsion 5-2.

Preparation of Specific Resin Particle Dispersion 5

An anionic surfactant (15.0 parts, DOWFAX manufactured by The Dow Chemical Company) and 90 parts of deionized water are added to a reactor equipped with a stirrer and a nitrogen introduction tube and stirred. The entirety of the emulsion 5-1 is added thereto, and 10 parts of ammonium persulfate having a concentration of 10% by mass is further added thereto.

The reactor is cleaned out by nitrogen purging, the reaction solution is heated in an oil bath while being stirred so that the temperature of the reaction solution reaches 75° C. The reaction solution is stirred for 2 hours while being kept at the same temperature, thereby performing emulsion polymerization.

Thereafter, 1,000 parts of the emulsion 5-2 is added to the reactor, the reaction solution is heated in an oil bath while being stirred so that the temperature of the reaction solution reaches 60° C., emulsion polymerization is carried out by stirring the reaction solution for 4 hours in a state where the temperature of the reaction solution is being maintained, and then the reaction solution is cooled to room temperature. Deionized water is added thereto, thereby obtaining a specific resin particle dispersion 5 having a solid content concentration of 35% by mass.

Preparation of Specific Resin Particle Dispersion 6

A specific resin particle dispersion 6 is obtained in the same manner as in <Preparation of specific resin particle dispersion 1>, except that in (Preparation of emulsion 1-1), the amount of styrene added to the mixing vessel is charged to 30 parts, the amount of n-butyl acrylate added to the mixing vessel is changed to 70 parts, and the amount of divinylbenzene added to the mixing vessel is changed to 1.8 parts; and in (Preparation of emulsion 1-2), the amount of styrene added to the mixing vessel is charged to 300 parts, the amount of n-butyl acrylate added to the mixing vessel is changed to 700 parts, the amount of divinylbenzene added to the mixing vessel is changed to 18 parts, and the time of stirring performed after the addition of an anionic surfactant and deionized water is changed to 4 hours.

Preparation of Specific Resin Particle Dispersion 7

A specific resin particle dispersion 7 is obtained in the same manner as in <Preparation of specific resin particle dispersion 1>, except that in (Preparation of emulsion 1-1), the amount of styrene added to the mixing vessel is charged to 35 parts, the amount of n-butyl acrylate added to the mixing vessel is changed to 65 parts, and the amount of divinylbenzene added to the mixing vessel is changed to 1.8 parts; and in (Preparation of emulsion 1-2), the amount of styrene added to the mixing vessel is charged to 350 parts, the amount of n-butyl acrylate added to the mixing vessel is changed to 650 parts, the amount of divinylbenzene added to the mixing vessel is changed to 18 parts, and the time of stirring performed after the addition of an anionic surfactant and deionized water is changed to 4 hours.

Preparation of Specific Resin Particle Dispersion 8

A specific resin particle dispersion 8 is obtained in the same manner as in <Preparation of specific resin particle dispersion 1>, except that in (Preparation of emulsion 1-1), the amount of styrene added to the mixing vessel is changed to 35 parts, the amount of n-butyl acrylate added to the mixing vessel is changed to 65 parts, and the amount of divinylbenzene added to the mixing vessel is changed to 1.9 parts; and in (Preparation of emulsion 1-2), the amount of styrene added to the mixing vessel is charged to 350 parts, the amount of n-butyl acrylate added to the mixing vessel is changed to 650 parts, and the amount of divinylbenzene added to the mixing vessel is changed to 19 parts.

Preparation of Specific Resin Particle Dispersion 9

A specific resin particle dispersion 9 is obtained in the same manner as in <Preparation of specific resin particle dispersion 1> described above, except that in (Preparation of emulsion 1-1), the amount of styrene added to the mixing vessel is changed to 50 parts, the amount of n-butyl acrylate added to the mixing vessel is changed to 50 parts, and the amount of divinylbenzene added to the mixing vessel is changed to 2.2 parts.

Preparation of Specific Resin Particle Dispersion 10

A specific resin particle dispersion 10 is obtained in the same manner as in <Preparation of specific resin particle dispersion 1> described above, except that in (Preparation of emulsion 1-1), the amount of styrene added to the mixing vessel is changed to 52 parts, the amount of n-butyl acrylate added to the mixing vessel is changed to 48 parts, and the amount of divinylbenzene added to the mixing vessel is changed to 2.2 parts.

Preparation of Specific Resin Particle Dispersion 11

A specific resin particle dispersion 11 is obtained in the same manner as in <Preparation of specific resin particle dispersion 1> described above, except that in (Preparation of emulsion 1-1) described above, 40 parts of styrene as a material added to the mixing vessel is changed to 35 parts of styrene, and 60 parts of n-butyl acrylate as a material added to the mixing vessel is changed to 65 parts of 2-ethylhexyl acrylate; and in (Preparation of emulsion 1-2) described above, 600 parts of styrene as a material added to the mixing vessel is changed to 350 parts of styrene, and 400 parts of n-butyl acrylate as a material added to the mixing vessel is changed to 650 parts of 2-ethylhexyl acrylate.

Preparation of Specific Resin Particle Dispersion 12

A specific resin particle dispersion 12 is obtained in the same manner as in <Preparation of specific resin particle dispersion 1> described above, except that in (Preparation of emulsion 1-1) described above, 60 parts of n-butyl acrylate as a material added to the mixing vessel is changed to 60 parts of 2-ethylhexyl acrylate; and in (Preparation of emulsion 1-2) described above, 600 parts of styrene as a material added to the mixing vessel is changed to 400 parts of styrene, and 400 parts of n-butyl acrylate as a material added to the mixing vessel is changed to 600 parts of 2-ethylhexyl acrylate.

Preparation of Specific Resin Particle Dispersion 13

A specific resin particle dispersion 13 is obtained in the same manner as in <Preparation of specific resin particle dispersion 1> described above, except that in (Preparation of emulsion 1-1) described above, 60 parts of n-butyl acrylate as a material added to the mixing vessel is changed to 60 parts of acryl isostearate; and in (Preparation of emulsion 1-2) described above, 600 parts of styrene as a material added to the mixing vessel is changed to 400 parts of styrene, and 400 parts of n-butyl acrylate as a material added to the mixing vessel is changed to 600 parts of acryl isostearate.

<Preparation of Specific Resin Particle Dispersion 14>

A specific resin particle dispersion 14 is obtained in the same manner as in <Preparation of specific resin particle dispersion 1> described above, except that in (Preparation of emulsion 1-1) described above, 40 parts of styrene as a material added to the mixing vessel is changed to 42 parts of styrene, and 60 parts of n-butyl acrylate as a material added to the mixing vessel is changed to 58 parts of acryl isostearate; and in (Preparation of emulsion 1-2) described above, 600 parts of styrene as a material added to the mixing vessel is changed to 420 parts of styrene, and 400 parts of n-butyl acrylate as a material added to the mixing vessel is changed to 580 parts of acryl isostearate.

Preparation of Specific Resin Particle Dispersion 15

A specific resin particle dispersion 15 is obtained in the same manner as in <Preparation of specific resin particle dispersion 1> described above, except that in (Preparation of emulsion 1-1) described above, 40 parts of styrene as a material added to the mixing vessel is changed to 35 parts of styrene, 60 parts of n-butyl acrylate as a material added to the mixing vessel is changed to 65 parts of 2-ethylhexyl acrylate, and 2.0 parts of divinylbenzene as a material added to the mixing vessel is changed to 2.5 parts of divinylbenzene; in (Preparation of emulsion 1-2) described above, 600 parts of styrene as a material added to the mixing vessel is changed to 350 parts of styrene, 400 parts of n-butyl acrylate as a material added to the mixing vessel is changed to 650 parts of 2-ethylhexyl acrylate, and 2.0 parts of divinylbenzene as a material added to the mixing vessel is changed to 25 parts of divinylbenzene; and in (Preparation of specific resin particle dispersion 1) described above, the temperature of the first reaction solution is changed to 70° C. from 60° C.

Preparation of Specific Resin Particle Dispersion 16

A specific resin particle dispersion 16 is obtained in the same manner as in <Preparation of specific resin particle dispersion 1> described above, except that in (Preparation of emulsion 1-1) described above, 40 parts of styrene as a material added to the mixing vessel is changed to 35 parts of styrene, 60 parts of n-butyl acrylate as a material added to the mixing vessel is changed to 60 parts of 2-ethylhexyl acrylate, and 2.0 parts of divinylbenzene as a material added to the mixing vessel is changed to 2.5 parts of divinylbenzene; and in (Preparation of emulsion 1-2) described above, 600 parts of styrene as a material added to the mixing vessel is changed to 400 parts of styrene, 400 parts of n-butyl acrylate as a material added to the mixing vessel is changed to 600 parts of 2-ethylhexyl acrylate, and 2.0 parts of divinylbenzene as a material added to the mixing vessel is changed to 25 parts of divinylbenzene.

Preparation of Specific Resin Particle Dispersion 17

A specific resin particle dispersion 17 is obtained in the same manner as in <Preparation of specific resin particle dispersion 1> described above, except that in (Preparation of emulsion 1-1) and (preparation of emulsion 1-2) described above, divinylbenzene is not added.

Preparation of Specific Resin Particle Dispersion 18

| | |
|---|---|
| Amorphous resin dispersion | 150 parts by mass |
| Deionized water | 175 parts by mass |
| n-Butyl acrylate | 170 parts by mass |
| 10% aqueous ammonia | 3 parts by mass |

The reactor is cleaned out by nitrogen purging, and the above materials are mixed together and heated to 75° C. while being stirred. A solution prepared by dissolving 1.5 parts by mass of ammonium persulfate in 100 parts by mass of deionized water is added dropwise thereto for 2 hours. Furthermore, the solution is reacted at 75° C. for 3 hours, thereby obtaining a specific resin particle dispersion 18.

Preparation of Specific Resin Particle Dispersion 19

A specific resin particle dispersion 19 is obtained in the same manner as in <Preparation of specific resin particle dispersion 1> described above, except that in (Preparation of emulsion 1-1) described above, 40 parts of styrene as a material added to the mixing vessel is changed to 18 parts of styrene, and 60 parts of n-butyl acrylate as a material added to the mixing vessel is changed to 82 parts of acryl isostearate; and in (Preparation of emulsion 1-2) described above, 600 parts of styrene as a material added to the mixing vessel is changed to 180 parts of styrene, and 400 parts of n-butyl acrylate as a material added to the mixing vessel is changed to 820 parts of acryl isostearate.

Preparation of Specific Resin Particle Dispersion 20

A specific resin particle dispersion 20 is obtained in the same manner as in <Preparation of specific resin particle dispersion 1> described above, except that in (Preparation of emulsion 1-1) described above, 40 parts of styrene as a material added to the mixing vessel is changed to 20 parts of styrene, and 60 parts of n-butyl acrylate as a material added to the mixing vessel is changed to 80 parts of acryl isostearate; and in (Preparation of emulsion 1-2) described above, 600 parts of styrene as a material added to the mixing vessel is changed to 200 parts of styrene, and 400 parts of n-butyl acrylate as a material added to the mixing vessel is changed to 800 parts of acryl isostearate.

Preparation of Specific Resin Particle Dispersion 21

A specific resin particle dispersion 21 is obtained in the same manner as in <Preparation of specific resin particle dispersion 1> described above, except that in (Preparation of emulsion 1-1) described above, 40 parts of styrene as a material added to the mixing vessel is changed to 50 parts of styrene, and 60 parts of n-butyl acrylate as a material added to the mixing vessel is changed to 50 parts of cyclohexyl acrylate; and in (Preparation of emulsion 1-2) described above, 600 parts of styrene as a material added to the mixing vessel is changed to 500 parts of styrene, and 400 parts of n-butyl acrylate as a material added to the mixing vessel is changed to 500 parts of cyclohexyl acrylate.

Preparation of Specific Resin Particle Dispersion 22

A specific resin particle dispersion 22 is obtained in the same manner as in <Preparation of specific resin particle dispersion 1> described above, except that in (Preparation of emulsion 1-1) described above, 40 parts of styrene as a material added to the mixing vessel is changed to 45 parts of styrene, and 60 parts of n-butyl acrylate as a material added to the mixing vessel is changed to 55 parts of cyclohexyl acrylate; and in (Preparation of emulsion 1-2) described above, 600 parts of styrene as a material added to the mixing vessel is changed to 450 parts of styrene, and 400 parts of n-butyl acrylate as a material added to the mixing vessel is changed to 550 parts of cyclohexyl acrylate.

Preparation of Specific Resin Particle Dispersion 23

A specific resin particle dispersion 23 is obtained in the same manner as in <Preparation of specific resin particle dispersion 1> described above, except that in (Preparation of emulsion 1-1) described above, 40 parts of styrene as a material added to the mixing vessel is changed to 49 parts of styrene, and 60 parts of n-butyl acrylate as a material added to the mixing vessel is changed to 51 parts of cyclohexyl acrylate; and in (Preparation of emulsion 1-2) described above, 600 parts of styrene as a material added to the mixing vessel is changed to 490 parts of styrene, and 510 parts of n-butyl acrylate as a material added to the mixing vessel is changed to 550 parts of cyclohexyl acrylate.

Preparation of Specific Resin Particle Dispersion 24

A specific resin particle dispersion 24 is obtained in the same manner as in <Preparation of specific resin particle dispersion 1> described above, except that in (Preparation of emulsion 1-1) described above, 60 parts of n-butyl acrylate as a material added to the mixing vessel is changed to 60 parts of cyclohexyl acrylate; and in (Preparation of emulsion 1-2) described above, 600 parts of styrene as a material added to the mixing vessel is changed to 400 parts of styrene, and 510 parts of n-butyl acrylate as a material added to the mixing vessel is changed to 600 parts of cyclohexyl acrylate.

Preparation of Specific Resin Particle Dispersion 25

A specific resin particle dispersion 25 is obtained in the same manner as in <Preparation of specific resin particle dispersion 1>, except that in (Preparation of emulsion 1-1) described above, the amount of the anionic surfactant added is changed to 2.2 parts.

Preparation of Specific Resin Particle Dispersion 26

A specific resin particle dispersion 26 is obtained in the same manner as in <Preparation of specific resin particle dispersion 1>, except that in (Preparation of emulsion 1-1) described above, the amount of the anionic surfactant added is changed to 2.0 parts.

Preparation of Specific Resin Particle Dispersion 27

A specific resin particle dispersion 27 is obtained in the same manner as in <Preparation of specific resin particle dispersion 1>, except that in (Preparation of emulsion 1-1) described above, the amount of the anionic surfactant added is changed to 0.015 parts.

Preparation of Specific Resin Particle Dispersion 28

A specific resin particle dispersion 28 is obtained in the same manner as in <Preparation of specific resin particle dispersion 1>, except that in (Preparation of emulsion 1-1) described above, the amount of the anionic surfactant added is changed to 0.01 parts.

Preparation of Specific Resin Particle Dispersion 29

According to Preparation of styrene acrylic resin particle dispersion (1) disclosed in Japanese Patent No. 6274057, a specific resin particle dispersion 29 is prepared as follows.
Styrene: 77 parts
n-Butyl acrylate: 23 parts
1,10-decanediol diacrylate: 0.4 parts
Dodecanethiol: 0.7 parts

The above materials are mixed together and dissolved. The obtained solution is mixed with a solution prepared by dissolving 1.0 part of an anionic surfactant (DOWFAX 2A1 manufactured by The Dow Chemical Company) in 60 parts of deionized water, the resulting solution is dispersed and emulsified in a flask, thereby preparing an emulsion.

Subsequently, 2.0 parts of an anionic surfactant (DOWFAX 2A1 manufactured by The Dow Chemical Company) is dissolved in 90 parts of deionized water, 20 parts of the aforementioned emulsion is added thereto, and 10 parts of deionized water in which 1.0 part of ammonium persulfate is dissolved is further added thereto.

Thereafter, the rest of the emulsion is added thereto for 3 hours, the flask is cleaned out by nitrogen purging, then the solution in the flask is heated up to 65° C. in an oil bath while being stirred, and the emulsion polymerization is continued as it is for 5 hours, thereby obtaining a specific resin particle dispersion 29. Deionized water is added to the specific resin particle dispersion 29 as necessary so that the solid content is adjusted to 35%.

Preparation of Colorant Dispersion
C. I. Pigment Blue 15: 3 (Dainichiseika Color & Chemicals Mfg.Co., Ltd.): 70 parts
Anionic surfactant (NEOGEN RK, manufactured by DKS Co. Ltd.): 5 parts
Deionized water 200 parts

The above materials are mixed together and dispersed for 10 minutes by using a homogenizer (ULTRA-TURRAX T50 manufactured by IKA). Deionized water is added thereto so that the solid content in the dispersion is 20% by mass, thereby obtaining a colorant dispersion in which colorant particles having a volume-average particle size of 170 nm are dispersed.

Preparation of Release Agent Dispersion
Paraffin wax [HNP-9, manufactured by NIPPON SEIRO CO., LTD.]: 50 parts
Anionic surfactant (NEOGEN RK, manufactured by DKS Co. Ltd.): 1 part
Deionized water: 150 parts

The above materials are mixed together, heated to 95° C., and dispersed using a homogenizer (ULTRA-TURRAX T50 manufactured by IKA). Then, by using Munton Gorlin high-pressure homogenizer (manufactured by Gorlin), dispersion treatment is performed, thereby obtaining a release agent dispersion (solid content of 30% by mass) in which release agent particles are dispersed. The volume-average particle size of the release agent particles is 180 nm.

### Example 1

Amorphous resin particle dispersion: 150 parts
Crystalline resin particle dispersion 1: 41 parts
Specific resin particle dispersion 1: 21 parts
Colorant dispersion: 39 parts
Release agent dispersion: 14 parts
Anionic surfactant (NEOGEN RK, manufactured by DKS Co. Ltd.): 15 parts
Deionized water: 100 parts

The above materials are put in a reactor equipped with a thermometer, a pH meter, and a stirrer, heated to a temperature of 30° C. from the outside with a mantle heater, and kept as it is for 30 minutes while being stirred at a rotation speed of 150 rpm. Thereafter, a 0.3 N aqueous nitric acid solution is added thereto so that the pH is adjusted to 3.0, and then a 3% by mass aqueous polyaluminum chloride solution is added thereto in a state where the reaction solution is being dispersed with a homogenizer (ULTRA-TURRAX T50 manufactured by IKA). Then, in a state where the reaction solution is being stirred, the temperature thereof is raised to 50° C. and kept for 30 minutes. Subsequently, 70 parts of the amorphous resin particle dispersion is added thereto, the reaction solution is kept as it is for 1 hour, a 0.1 N aqueous sodium hydroxide solution is added thereto so that the pH is adjusted to 8.5, and the reaction solution is then heated to 85° C. while being continuously stirred and kept as it is for 5 hours. Thereafter, cooling, solid-liquid separation, washing and drying of the solids are sequentially carried out, thereby obtaining toner particles having a volume-average particle size of 4.8 μm.

The obtained toner particles (100 parts) and 0.7 parts of silica particles treated with dimethylsilicone oil (RY200 manufactured by Nippon Aerosil Co., Ltd.) are mixed together by a henschel mixer, thereby obtaining a toner.

Then, 8 parts of the obtained toner and 100 parts of the following carrier are mixed together, thereby obtaining a developer.

Preparation of Carrier

| | |
|---|---|
| Ferrite particles (average particle size 50 μm) | 100 parts |
| Toluene | 14 parts |
| Styrene-methyl methacrylate copolymer | 3 parts |
| (copolymerization ratio 15/85) | |
| Carbon black | 0.2 parts |

The above components excluding the ferrite particles are dispersed with a sand mill, thereby preparing a dispersion. The dispersion is put in a vacuum deaeration-type kneader together with the ferrite particles, and dried under reduced pressure while being stirred, thereby obtaining a carrier.

### Examples 2 to 3, 9 to 11, 18 and 19, 29 and 30, 32 to 35, and 40 to 43 and Comparative Examples 1, 2, and 4

Toner particles, a toner, and a developer of each example are obtained in the same manner as in Example 1, except that the specific resin particle dispersion 1 is changed to the specific resin particle dispersion described in Table 1.

### Examples 4, 5, 8, and 22 to 28 and Comparative Example 3

Toner particles, a toner, and a developer of each example are obtained in the same manner as in Example 1, except that the amount of the amorphous resin dispersion, the crystalline resin particle dispersion 1, and the specific resin particle dispersion 1 added to the reactor in preparing toner particles is changed as follows.

### Example 4

Amorphous resin dispersion: 157 parts

Crystalline resin particle dispersion 1: 56 parts

Specified resin particle dispersion 1: 4.0 parts

### Example 5

Amorphous resin dispersion: 152 parts

Crystalline resin particle dispersion 1: 34 parts

Specific resin particle dispersion 1: 25 parts

### Example 8

Amorphous resin dispersion: 153 parts

Crystalline resin particle dispersion 1: 10 parts

Specific resin particle dispersion 1: 43 parts

### Example 22

Amorphous resin particle dispersion: 81 parts

Crystalline resin particle dispersion 1: 135.0 parts

Specified resin particle dispersion 1: 4.0 parts

### Example 23

Amorphous resin particle dispersion: 106 parts

Crystalline resin particle dispersion 1: 109.0 parts

Specified resin particle dispersion 1: 4.0 parts

### Example 24

Amorphous resin particle dispersion: 150 parts

Crystalline resin particle dispersion 1: 11.0 parts

Specified resin particle dispersion 1: 44.0 parts

### Example 25

Amorphous resin particle dispersion: 206 parts

Crystalline resin particle dispersion 1: 6 parts

Specified resin particle dispersion 1: 2 parts

### Example 26

Amorphous resin particle dispersion: 206 parts

Crystalline resin particle dispersion 1: 6 parts

Specified resin particle dispersion 1: 3 parts

### Example 27

Amorphous resin particle dispersion: 109 parts

Crystalline resin particle dispersion 1: 30 parts

Specified resin particle dispersion 1: 63 parts

### Example 28

Amorphous resin particle dispersion: 108 parts

Crystalline resin particle dispersion 1: 29 parts

Specific resin particle dispersion 1: 65 parts

### Comparative Example 3

Amorphous resin dispersion: 152 parts

Crystalline resin particle dispersion 1: 0 parts

Specific resin particle dispersion 1: 50 parts

### Examples 6, 7, 12 to 17, 20, 21, 31, and 36 to 39

Toner particles, a toner, and a developer of each example are obtained in the same manner as in Example 1, except that the types of crystalline resin particle dispersion and specific resin particle dispersion are changed to the combinations described in Table 1.

Gloss Unevenness Evaluation

The variation of gloss is calculated. The results are shown tables.

A standard deviation σ is calculated for a total of 50 measured values of 60° gloss measured for calculating “gloss of image after heating”. Based on the standard deviation σ, gloss unevenness is evaluated according to the following evaluation criteria.

### Evaluation Criteria

A: σ<3.0

B: 3.0≤σ<5.0

C: 5.0≤σ<8.0

D: 8.0≤σ

TABLE 1

| | | | | | | | | | | | Relationship between binder resin and | | | | | | |
|---|---|---|---|---|---|---|---|---|---|---|---|---|---|---|---|---|---|
| | Crystalline resin | | Specific resin particles | | | | | | | | specific resin particles | | | | | Evaluation | |
| | Type of | | Specific | Presence or | | | | | tanδS | | tanδS | tanδS | | SP value | SP value | Gloss | Results of |
| | crystalline | Type of | resin | absence of | Type of | | | | (30) − | Dispersion | (30)/ | (50)/ | | (S) − SP | (S) − SP | rate of | evaluation on |
| | resin particle | crystalline | particle | bridging | resin | Content | tanδS | tanδS | tanδS | diameter | tanδC | tanδC | Ratio | value | value | change | gloss |
| | dispersion | resin | dispersion | structure | particles | (%) | (30) | (50) | (50) | (nm) | (30) | (50) | (S/C) | (R) | (C) | (%) | unevenness |
| Example 1 | 1 | Crystalline PES | 1 | Present | St/Ac | 10 | 2 | 0.5 | 1.5 | 200 | 40 | 5.0 | 0.7 | −0.1 | 1.0 | 3 | A |
| Example 2 | 1 | Crystalline PES | 2 | Present | St/Ac | 10 | 1.1 | 0.5 | 0.6 | 200 | 22 | 5.0 | 0.7 | −0.2 | 0.8 | 5 | B |
| Example 3 | 1 | Crystalline PES | 3 | Present | St/Ac | 10 | 2 | 0.9 | 1.1 | 200 | 40 | 9.0 | 0.7 | −0.1 | 1.0 | 7 | B |
| Example 4 | 1 | Crystalline PES | 1 | Present | St/Ac | 1.8 | 2 | 0.5 | 1.5 | 200 | 40 | 5.0 | 0.1 | −0.1 | 1.0 | 7 | B |
| Example 5 | 1 | Crystalline PES | 1 | Present | St/Ac | 12 | 2 | 0.5 | 1.5 | 200 | 40 | 5.0 | 1 | −0.1 | 1.0 | 7 | B |
| Example 6 | 2 | Crystalline PES | 3 | Present | St/Ac | 10 | 2 | 0.9 | 1.1 | 200 | 50 | 12.9 | 0.7 | −0.1 | 1.0 | 7 | B |
| Example 7 | 3 | Crystalline PES | 1 | Present | St/Ac | 10 | 2 | 0.5 | 1.5 | 200 | 25 | 3.3 | 0.7 | −0.1 | 1.0 | 3 | A |
| Comparative | 1 | Crystalline PES | 4 | Present | St/Ac | 10 | 0.9 | 0.5 | 0.4 | 200 | 18 | 5.0 | 0.7 | −0.1 | 1.0 | 12 | D |
| Example 1 | | | | | | | | | | | | | | | | | |
| Comparative | 1 | Crystalline PES | 5 | Present | St/Ac | 10 | 2 | 1.1 | 0.9 | 200 | 40 | 11.0 | 0.7 | −0.1 | 1.0 | 13 | D |
| Example 2 | | | | | | | | | | | | | | | | | |
| Comparative | — | — | 1 | Present | St/Ac | 24 | 2 | 0.5 | 1.5 | 200 | — | — | — | −0.1 | — | 11 | D |
| Example 3 | | | | | | | | | | | | | | | | | |
| Comparative | 1 | Crystalline PES | 29 | Present | St/Ac | 10 | 0.03 | 0.05 | −0.02 | 200 | 0.6 | 0.5 | 0.7 | 0.2 | 1.1 | 14 | D |
| Example 4 | | | | | | | | | | | | | | | | | |
| Example 8 | 1 | Crystalline PES | 1 | Present | St/Ac | 20 | 2 | 0.5 | 1.5 | 200 | 40 | 5.0 | 5.5 | −0.1 | 1.0 | 11 | C |
| Example 9 | 1 | Crystalline PES | 6 | Present | St/Ac | 10 | 1.2 | 0.8 | 0.4 | 200 | 24 | 8.0 | 0.7 | −0.2 | 0.8 | 9 | C |
| Example 10 | 1 | Crystalline PES | 7 | Present | St/Ac | 10 | 1.5 | 0.9 | 0.6 | 200 | 30 | 9.0 | 0.7 | −0.2 | 0.8 | 8 | C |
| Example 11 | 1 | Crystalline PES | 8 | Present | St/Ac | 10 | 1.7 | 0.8 | 0.9 | 200 | 34 | 8.0 | 0.7 | −0.2 | 0.8 | 6 | B |
| Example 12 | 3 | Crystalline PES | 9 | Present | St/Ac | 10 | 3.4 | 0.5 | 2.9 | 200 | 43 | 3.3 | 0.7 | −0.1 | 1.0 | 5 | B |
| Example 13 | 3 | Crystalline PES | 10 | Present | St/Ac | 10 | 3.6 | 0.5 | 3.1 | 200 | 45 | 3.3 | 0.7 | −0.1 | 1.0 | 9 | C |
| Example 14 | 3 | Crystalline PES | 11 | Present | St/Ac | 10 | 1.5 | 0.5 | 1 | 200 | 18.8 | 3.3 | 0.7 | −1.0 | 0.1 | 9 | C |
| Example 15 | 3 | Crystalline PES | 12 | Present | St/Ac | 10 | 1.7 | 0.5 | 1.2 | 200 | 21.3 | 3.3 | 0.7 | −0.9 | 0.1 | 7 | B |
| Example 16 | 2 | Crystalline PES | 13 | Present | St/Ac | 10 | 2.3 | 0.6 | 1.7 | 200 | 57.5 | 8.6 | 0.7 | −0.9 | 0.2 | 8 | B |
| Example 17 | 2 | Crystalline PES | 14 | Present | St/Ac | 10 | 2.5 | 0.6 | 1.9 | 200 | 62.5 | 8.6 | 0.7 | −0.9 | 0.2 | 9 | C |
| Example 18 | 1 | Crystalline PES | 15 | Present | St/Ac | 10 | 2 | 0.16 | 1.84 | 200 | 40 | 1.6 | 0.7 | −1.0 | 0.1 | 9 | C |
| Example 19 | 1 | Crystalline PES | 16 | Present | St/Ac | 10 | 2 | 0.22 | 1.78 | 200 | 40 | 2.2 | 0.7 | −0.9 | 0.1 | 7 | B |
| Example 20 | 8 | Crystalline PES | 8 | Present | St/Ac | 10 | 1.7 | 0.8 | 0.9 | 200 | 56.7 | 19.0 | 0.7 | −0.1 | 1.0 | 6 | B |
| Example | 8 | Crystalline | 7 | Present | St/Ac | 10 | 1.5 | 0.9 | 0.6 | 200 | 50 | 21.4 | 0.7 | −0.1 | 1.0 | 8 | C |
| 21 | | PES | | | | | | | | | | | | | | | |
| Example | 1 | Crystalline | 1 | Present | St/Ac | 2 | 2 | 0.5 | 1.5 | 200 | 40 | 5.0 | 0.04 | −0.1 | 1.0 | 9 | C |
| 22 | | PES | | | | | | | | | | | | | | | |
| Example | 1 | Crystalline | 1 | Present | St/Ac | 2 | 2 | 0.5 | 1.5 | 200 | 40 | 5.0 | 0.05 | −0.1 | 1.0 | 7 | B |
| 23 | | PES | | | | | | | | | | | | | | | |
| Example | 1 | Crystalline | 1 | Present | St/Ac | 20 | 2 | 0.5 | 1.5 | 200 | 40 | 5.0 | 5.0 | −0.1 | 1.0 | 9 | C |
| 24 | | PES | | | | | | | | | | | | | | | |
| Example | 1 | Crystalline | 1 | Present | St/Ac | 0.9 | 2 | 0.5 | 1.5 | 200 | 40 | 5.0 | 0.45 | −0.1 | 1.0 | 10 | C |
| 25 | | PES | | | | | | | | | | | | | | | |
| Example | 1 | Crystalline | 1 | Present | St/Ac | 1.1 | 2 | 0.5 | 1.5 | 200 | 40 | 5.0 | 0.55 | −0.1 | 1.0 | 7 | B |
| 26 | | PES | | | | | | | | | | | | | | | |
| Example | 1 | Crystalline | 1 | Present | St/Ac | 30 | 2 | 0.5 | 1.5 | 200 | 40 | 5.0 | 2.77 | −0.1 | 1.0 | 6 | B |
| 27 | | PES | | | | | | | | | | | | | | | |
| Example | 1 | Crystalline | 1 | Present | St/Ac | 31 | 2 | 0.5 | 1.5 | 200 | 40 | 5.0 | 2.92 | −0.1 | 1.0 | 9 | C |
| 28 | | PES | | | | | | | | | | | | | | | |
| Example | 1 | Crystalline | 17 | Absent | St/Ac | 10 | 2.7 | 0.9 | 1.8 | 200 | 54 | 9 | 0.7 | −0.1 | 1.0 | 9 | C |
| 29 | | POE | | | | | | | | | | | | | | | |
| Example | 1 | Crystalline | 18 | Present | PES/Ac | 10 | 2 | 0.5 | 1.5 | 200 | 40 | 5.0 | 0.7 | −0.1 | 0.9 | 10 | C |
| 30 | | PES | | | | | | | | | | | | | | | |
| Example | 4 | Crystalline | 1 | Present | St/Ac | 10 | 2 | 0.5 | 1.5 | 200 | 40 | 5.0 | 0.7 | 0.3 | 1.4 | 10 | C |
| 31 | | PES | | | | | | | | | | | | | | | |
| Example | 1 | Crystalline | 19 | Present | St/Ac | 10 | 2 | 0.5 | 1.5 | 200 | 40 | 5.0 | 0.7 | −1.1 | 0.0 | 9 | C |
| 32 | | PES | | | | | | | | | | | | | | | |
| Example | 1 | Crystalline | 20 | Present | St/Ac | 10 | 2 | 0.5 | 1.5 | 200 | 40 | 5.0 | 0.7 | −1 | 0.0 | 6 | B |
| 33 | | PES | | | | | | | | | | | | | | | |
| Example | 1 | Crystalline | 21 | Present | St/Ac | 10 | 2 | 0.5 | 1.5 | 200 | 40 | 5.0 | 0.7 | 1 | 1.9 | 6 | B |
| 34 | | PES | | | | | | | | | | | | | | | |
| Example | 1 | Crystalline | 22 | Present | St/Ac | 10 | 2 | 0.5 | 1.5 | 200 | 40 | 5.0 | 0.7 | 1.1 | 2.0 | 9 | C |
| 35 | | PES | | | | | | | | | | | | | | | |
| Example | 5 | Crystalline | 1 | Present | St/Ac | 10 | 2 | 0.5 | 1.5 | 200 | 40 | 5.0 | 0.7 | −0.1 | −0.1 | 9 | C |
| 36 | | PES | | | | | | | | | | | | | | | |
| Example | 6 | Crystalline | 1 | Present | St/Ac | 10 | 2 | 0.5 | 1.5 | 200 | 40 | 5.0 | 0.7 | −0.05 | 0 | 7 | B |
| 37 | | PES | | | | | | | | | | | | | | | |
| Example | 7 | Crystalline | 23 | Present | St/Ac | 10 | 2 | 0.5 | 1.5 | 200 | 40 | 5.0 | 0.7 | 0.9 | 2 | 7 | B |
| 38 | | PES | | | | | | | | | | | | | | | |
| Example | 7 | Crystalline | 24 | Present | St/Ac | 10 | 2 | 0.5 | 1.5 | 200 | 40 | 5.0 | 0.7 | 1.0 | 2.1 | 8 | C |
| 39 | | PES | | | | | | | | | | | | | | | |
| Example | 1 | Crystalline | 25 | Present | St/Ac | 10 | 2 | 0.5 | 1.5 | 45 | 40 | 5.0 | 0.7 | −0.1 | 1.0 | 9 | C |
| 40 | | PES | | | | | | | | | | | | | | | |
| Example | 1 | Crystalline | 26 | Present | St/Ac | 10 | 2 | 0.5 | 1.5 | 50 | 40 | 5.0 | 0.7 | −0.1 | 1.0 | 7 | B |
| 41 | | PES | | | | | | | | | | | | | | | |
| Example | 1 | Crystalline | 27 | Present | St/Ac | 10 | 2 | 0.5 | 1.5 | 500 | 40 | 5.0 | 0.7 | −0.1 | 1.0 | 8 | B |
| 42 | | PES | | | | | | | | | | | | | | | |
| Example | 1 | Crystalline | 28 | Present | St/Ac | 10 | 2 | 0.5 | 1.5 | 510 | 40 | 5.0 | 0.7 | −0.1 | 1.0 | 9 | C |
| 43 | | PES | | | | | | | | | | | | | | | |

The abbreviations in the tables will be described below.
Crystalline PES: crystalline polyester resin
Crystalline POE: crystalline polyether resin
St/Ac: styrene-(meth)acrylic copolymer resin particles
PES/Ac: specific resin particles containing polyester resin and acrylic resin
“Content (%)” of specific resin particles: content of resin particles with respect to total mass of electrostatic charge image developing toner

As is evident from the above results, the toner of the present example excellently suppresses gloss unevenness that may occur after the temperature of an image is raised.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
a binder resin that contains a crystalline resin; and
toner particles that contain resin particles,
wherein a loss coefficient tan δS (30) at 30° C. of the resin particles is 1 or more, and
a loss coefficient tan δS (50) at 50° C. of the resin particles is less than 1.

2. The electrostatic charge image developing toner according to claim 1,
wherein a difference between the loss coefficient tan δS (30) and the loss coefficient tan δS (50) (tan δS (30)−tan δS (50)) is 0.5 or more.

3. The electrostatic charge image developing toner according to claim 2,
wherein the difference between the loss coefficient tan δS (30) and the loss coefficient tan δS (50) (tan δS (30)−tan δS (50)) is 0.8 or more and 3.0 or less.

4. The electrostatic charge image developing toner according to claim 1,
wherein in a case where tan δC (30) represents a loss coefficient at 30° C. of the crystalline resin and tan δC (50) represents a loss coefficient at 50° C. of the crystalline resin, a ratio of the loss coefficient tan δS (30) to the loss coefficient tan δC (30) (tan δS (30)/tan δC (30)) is 20.0 or more and 60.0 or less, and a ratio of the loss coefficient tan δS (50) to the loss coefficient tan δC (50) (tan δS (50)/tan δC (50)) is 2.0 or more and 20.0 or less.

5. The electrostatic charge image developing toner according to claim 1,
wherein a ratio (S/C) of a content S of the resin particles to a content C of the crystalline resin is 0.05 or more and 5.0 or less based on mass.

6. The electrostatic charge image developing toner according to claim 1,
wherein a content of the resin particles is 1% by mass or more and 30% by mass or less with respect to a total mass of the electrostatic charge image developing toner.

7. The electrostatic charge image developing toner according to claim 1,
wherein the resin particles are crosslinked resin particles.

8. The electrostatic charge image developing toner according to claim 7,
wherein the crosslinked resin particles are styrene-(meth)acrylic copolymer resin particles.

9. The electrostatic charge image developing toner according to claim 8,
wherein the crystalline resin includes a crystalline polyester resin.

10. The electrostatic charge image developing toner according to claim 1,
wherein a difference between an SP value (S) as a solubility parameter of the resin particles and an SP value (R) as a solubility parameter of the binder resin (SP value (S)−SP value (R)) is −1.0 or more and 1.0 or less.

11. The electrostatic charge image developing toner according to claim 1,
wherein a difference between an SP value (S) as a solubility parameter of the resin particles and an SP value (C) as a solubility parameter of the crystalline resin (SP value (S)−SP value (C)) is 0 or more and 2.0 or less.

12. The electrostatic charge image developing toner according to claim 1,
wherein a dispersion diameter of the resin particles is 50 nm or more and 500 nm or less.

13. An electrostatic charge image developing toner, comprising:
toner particles that contain a binder resin containing a crystalline resin and resin particles,
wherein the electrostatic charge image developing toner yields a gloss rate of change of an image of 0% or more and 10.0% or less before and after heating the image at 50° C. for 30 days, the image being a 25 mm×25 mm square image formed at a toner application amount of 13.5 g/m².

14. An electrostatic charge image developer comprising:
the electrostatic charge image developing toner according to claim 1.

15. A toner cartridge comprising:
a container that contains the electrostatic charge image developing toner according to claim 1,
wherein the toner cartridge is detachable from an image forming apparatus.

16. A process cartridge comprising:
a developing unit that contains the electrostatic charge image developer according to claim 14 and develops an electrostatic charge image formed on a surface of an image holder as a toner image by using the electrostatic charge image developer,
wherein the process cartridge is detachable from an image forming apparatus.

17. An image forming apparatus comprising:
an image holder;
a charging unit that charges a surface of the image holder;
an electrostatic charge image forming unit that forms an electrostatic charge image on the charged surface of the image holder;
a developing unit that contains the electrostatic charge image developer according to claim 14 and develops the electrostatic charge image formed on the surface of the image holder as a toner image by using the electrostatic charge image developer;
a transfer unit that transfers the toner image formed on the surface of the image holder to a surface of a recording medium; and
a fixing unit that fixes the toner image transferred to the surface of the recording medium.

18. An image forming method comprising:
charging a surface of an image holder;
forming an electrostatic charge image on the charged surface of the image holder;
developing the electrostatic charge image formed on the surface of the image holder as a color toner image by using the color electrostatic charge image developer according to claim 14,
transferring the toner image formed on the surface of the image holder to a surface of a recording medium; and
fixing the toner image transferred to the surface of the recording medium.
